(19) United States
(12) Patent Application Publication
(10) Pub. No.: US 2011/0178830 A1
(43) Pub. Date: Jul. 21, 2011

(54) Computer-Implemented Tools and Method for Developing and Implementing Integrated Model of Strategic Goals

(75) Inventor: George Gordon Knowles, Dallas, TX (US)

(73) Assignee: COGNITI, INC., Plano, TX (US)

(21) Appl. No.: 13/010,534

(22) Filed: Jan. 20, 2011

Related U.S. Application Data
(60) Provisional application No. 61/296,560, filed on Jan. 20, 2010.

(51) Int. Cl. G06Q 10/00

(52) U.S. Cl. 705/7.11

(57) ABSTRACT

By building a computer model operating on a computerized device that integrates a strategy model and an operations model, it may be possible to better project the impact of implementing business strategies. And by computerized monitoring of the business's status, as indicated by its current financial data in comparison to the projections arising from the computer model, it may be possible to determine whether the business strategies are being successfully implemented. It would also be useful to have an automated system that would automatically notify personnel within a business if the business strategy is not being successfully implemented, allowing those personnel to intercede more quickly to correct problems. In addition to providing such a warning, it would also be useful to present the consequences, including the impact on financial data, people, processes, and technology, arising from the actual implementation of these strategies, along with a means of capturing the business correction measures used to correct such deviations. The present computerized framework, device, and method disclose embodiments for developing and using an integrated, closed-loop computerized business model, typically using a plurality of linked database tables.

### CROSS-REFERENCE TO RELATED APPLICATIONS

This Application is related to and claims benefit under 35 USC §119 to U.S. Provisional Patent Application Ser. No, 61/296,560 entitled “Computer-Implemented Method of Developing and Implementing Integrated Model of Strategic Goals” filed Jan. 20, 2010, which is assigned to the Assignee of the present application and hereby incorporated by reference as if reproduced in its entirety to the degree that it is not inconsistent with the information specifically set forth herein.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF INVENTION

The present invention is directed generally to computer modeling, and more specifically to computerized tools for developing and implementing integrated computer models of strategic and operational goals, as well as related methods for building and using computerized models.

### BACKGROUND

To achieve real-world benefits, it would be useful if businesses could construct effective computer models that link strategic goals to the operational elements that will implement those goals. Further, it would be useful if businesses could use the computer model to project the results of a particular strategy, and then to actually measure the ongoing strategy implementation to see if projections are being realized. And if the real-world measurements do not track the projections, it would be useful if an automated warning could be transmitted to assist in correcting issues that have resulted in the warning. Embodiments of the present invention(s) may attempt to address one or more of these issues by providing a computerized framework for developing and implementing an integrated model of strategic goals. In some embodiments, the computerized framework may also be used to guide the business in making specific physical modifications, such as automating processes or upgrading to more efficient technology in order to either implement the strategy or to correct any problems giving rise to deviations from the strategic projections.

### SUMMARY

In one aspect, the disclosure includes a method for building a computer model (typically including a strategy model and a related operations model), using the model to project value, checking the current financial status in comparison to the projection, and optionally transmitting a notice or warning to designated contact personnel and/or outlining financial consequences and potential corrective actions. Typically, the computer model will include benefit calculations, and the projection of value is based on these benefit calculations in conjunction with historic run-rate data. In another aspect, the disclosure includes a computer system for building a computer model (typically including a strategy model and a related operations model), using the model to project value, monitoring current value status (using current data from a host database), and evaluating whether the current value status is off-track based on the projection.

In one aspect, the disclosure includes a computerized method of automated measuring and monitoring of business progress/status comprising one or more of the following steps of: storing one or more strategy elements into a strategy model on a database; storing one or more operations elements into an operations model on the database; associating related elements in the strategy model; and associating related elements in the operations model; storing one or more benefit calculations associated with each operations element on the database; synchronizing the strategy model and the operations model; storing one or more execution control indicators and/or business process dependencies and associations on a database; storing on a database one or more corrective actions to performance deviations and associations across a series of units comprising an organization; projecting (by a computer/processor) value of the operations model; determining (by the computer/processor) current value status; comparing (by the computer/processor) current value status to projected value; transmitting (by automated means using one or more communications systems, such as telephone or wireless internet, for example) a warning in the event that the comparison of current value status to projected value is outside a pre-set limit; and determining (by computer/processor) business and financial consequences of deviation to limits set across a series of units within the organization; wherein some or all of the above steps are carried out on the computer/processor. In some embodiments, associating related elements might comprise assigning a guid to each element in the strategy model and to each element in the operations model, wherein each guid is hierarchically associated and segmented. In some embodiments, projecting value of the operations model might further comprise importing run-rate data from a run-rate database for use with the benefit calculations; and determining current value status might comprise importing current data from a host database for use with the benefit calculations (or ECI derived from the benefit calculations).

In another aspect, the disclosure includes a method of developing and implementing a computerized business model comprising one or more of the following steps of: constructing (on a computer/processor) a computerized strategy model; constructing (on a computer/processor) a computerized operations model; associating/linking elements in the operations model to related elements in the strategy model; synchronizing the strategy model and the operations model based on the associations/links; refining the operations and/or strategy models using solution design and/or process measurement; projecting (by a computer/processor) value of the operations model; determining (by a computer/processor) current value status; comparing (by a computer/processor) current value status to projected value; and transmitting a warning to pre-set contact personnel in the event that the comparison of current value status to projected value is outside a pre-set limit; wherein one or more of the above steps are carried out on/by a computer. In some embodiments, constructing a computerized strategy model comprises one or more of the following: setting a business driver, and setting one or more strategies associated with the business driver; constructing a computerized operations model comprises one or more of the following: setting one or more VCE, setting one or more goals associated with each VCE, and setting one or more business calculations associated with each goal; projecting value of the operations model comprises importing run-rate data from a run-rate database for use with the benefit calculations; and determining current value status comprises importing current data from a host database for use with the benefit calculations (or ECI derived from the benefit calculations), in some embodiments, setting a business driver might comprise selecting the business driver from a pre-set menu of business drivers on a database; setting one or more strategies associated with the business driver might comprise selecting the one or more strategies from a pre-set menu of strategies on the database; setting a VCE might comprise selecting the VCE from a pre-set menu of VCE on the database; setting one or more goals associated with the VCE might comprise selecting the one or more goals from a pre-set menu of goals on the database; and setting one or more business calculations associated with each goal might comprise selecting the one or more business calculations from a preset menu of business calculations on the database. And in some embodiments, the one or more goals might be associated with the VCE by guid; the one or more business calculations might be associated with each goal by guid; and each guid might be hierarchically associated and segmented.

In yet another aspect, the disclosure may include one or more databases (or any (computerized) means for storing) comprising or operable/configured for: one or more pre-set menus of strategy elements/components and their associations/links (i.e. how they are related), one or more pre-set menus of operations elements/components and their associations/links (i.e. how they are related), the associations between related operations elements/components and strategy elements/components, the run-rate financial data, storing a computerized model (including the strategy model and the operations model), storing contact information for notifications/warnings, storing triggers for checking current status (and evaluating it in comparison to projection) and/or limits for warning levels, and the host current financial data; and a computer (means) operable/configured for generating a projection based on the computerized model and the run-rate data, and periodically retrieving current host financial data and comparing it to the projection. In some embodiments, the computerized model might comprise a plurality of strategy elements selected from the pre-set menu of strategy elements, a plurality of operations elements selected from the pre-set menu of operations elements, and one or more benefit calculations for each such operations element in the computerized model. In some embodiments, the computer might further comprise a notification transmission unit to send a warning to contact personnel in the event that the comparison of current financial data to the projection is outside the limits and/or a user interface.

In still another aspect, the disclosure may include a computer system comprising one or more of the following: a strategy module; an operations module; a computer model; an execution control module; a run-rate database; and a host database.

In some embodiments, the strategy module might comprise a database of one or more pre-set menus of strategy elements and their associations/links (i.e. how they are related); and/or the operations module might comprises a database of one or more pre-set menus of operations elements and benefit calculations and their associations/links (i.e. how they are related). In some embodiments, the computer model might comprise a database storing one or more selected operations elements and one or more benefit calculations associated with each selected operations elements; and/or the execution control module might comprise a contact information database and a trigger/limit database. In some embodiment, the system might further comprise a database of the associations between related operations elements and strategy elements. And in some embodiments, the computer model might project value using the run-rate data and the benefit calculations, the execution control module might determine current status using the host data and the benefit calculations (or ECI based on them), and/or the execution control module might compare the current status to the projection (to determine if outside the limit and a warning should be transmitted to contact personnel).

In another exemplary aspect, a computer device/system might comprise (one or more databases having) a plurality of associated database entries, each entry having a hierarchical segmented guid (linking related electronically stored data). In some embodiments, the hierarchical segmented guid for each entry might operate to allow for associations to be determined between a specific entry and other entries in the one or more databases. In some embodiments, the associations between all related entries in the one or more databases might defined by the guid. In some embodiments, the one or more databases might comprise a plurality of operations elements and one or more benefit calculations associated via guid with each such operations element. There are many different possible variants of this inventive concept, as discussed in more detail below.

### BRIEF DESCRIPTION OF THE DRAWINGS

For a more complete understanding of the present disclosure, and for further details and advantages thereof, reference shall be made to the accompanying drawings:

FIG. 1 is a schematic illustrating run rate data;

FIG. 2 is a schematic diagram of an exemplary strategy model structure;

FIG. 3 is a schematic of an exemplary strategy model;

FIG. 4 is a schematic of an exemplary value assessment tool;

FIG. 5 is a schematic of an exemplary operations model;

FIG. 6 is a schematic of an exemplary benefit calculation construction tool;

FIG. 7 is a schematic of an exemplary distribution tool;

FIG. 8 is a schematic of an exemplary tool for associating benefit calculation to KPI;

FIG. 9 is a schematic of an exemplary tool for switching strategies;

FIG. 10 is a schematic of an exemplary tool for setting ECI;

FIG. 11 is a schematic of art exemplary tool for setting ECI limits;

FIG. 12 is a schematic of an exemplary tool for setting warning contact information;

FIG. 13 is a schematic of an exemplary synchronization tool;

FIG. 14 is a schematic of an exemplary tool for viewing distribution when synchronizing;

FIG. 15 is a schematic of an exemplary is a solution design tool;

FIG. 16 is a schematic of an exemplary tool for building cost elements for solution design;

FIG. 17 is a schematic of an exemplary tool for ROI analysis;

FIG. 18 is a schematic of an exemplary process measurement tool;

FIG. 19 is a schematic of an exemplary consequence manager tool;

FIG. 20 is a schematic of an exemplary correction manager tool;

FIG. 21 is a schematic of an exemplary tool for relating units in an n-tier organization;

FIG. 22 is a schematic of an exemplary tool for viewing n-tier organization elements;

FIG. 23 is a schematic of an exemplary computer system overview;

FIG. 24 is a schematic of an exemplary cogniti computer system;

FIG. 25 is a schematic of another exemplary computer system;

FIG. 26 is a schematic of an exemplary computer architecture; and

FIG. 27 is a schematic of exemplary interactions between a computer system and outside products.

### DETAILED DESCRIPTION

The present invention provides tools to assist in designing and implementing an overall strategy for an entity (such as a global corporation, a regional company, a division, a department, a team, or even an individual, for example). Within a computerized framework, a strategy model outlining corporate goals and an operations model detailing the implementation of those strategy goals may be constructed and linked. By refining an overall corporate model that integrates both strategic and operational elements, an improved computer model can be built, leading to better forecasting and improved accuracy in projecting the results of a particular business strategy. Furthermore, the computerized modeling framework allows for automated tracking of the real-world implementation of the selected business strategy, using a comparison of current data to the projection to see if the business strategy is proceeding on target or if refinement and adjustments must be made operationally to correct performance. And an integrated computerized framework also allows for automated notification if projections are not being met.

To assist in accomplishing such integrated modeling, several interconnected modules may be used within the computerized framework. Each module is typically designed to serve a specific individual purpose of its own (and could be used independently as a tool for that specific purpose), but when the modules are linked and used together they may provide additional synergistic benefits. A run-rate database containing historical reference data (typically financial data) or projected data of the entity at issue may serve as a benchmark for future measurements, and may interact with other modules in building, implementing, and assessing computer models relevant to business strategy. A strategy module may provide a tool that assists business decision-makers in building an effective strategy model designed to achieve the business goals of the entity and in assessing the potential value of the proposed strategy (to see if the strategy has the potential to provide the desired level of results, perhaps and allowing for iterative manipulations of the strategy model as necessary for the corporate goals to be achievable). An operations module may provide a tool that assists operational personnel in detailing the operational elements they intend to use to achieve the specific elements in the strategy model and tying those elements to a benefit calculation that estimates value with a greater degree of granularity using run-rate data. And an execution control module may provide a tool that assists the entity in tracking real-world performance (using current data, typically housed in the entity's (host) financial database) in comparison to the projections provided by one or more of the computer models (using historic reference run-rate data), to see if the entity's strategy is being successfully implemented (and perhaps notifying appropriate personnel if off-target).

A synchronization module may also be included, providing a tool that allows for comparison of the strategy model to the operations model in order to ensure that the operations side of the business is aligned with the overall corporate strategy. Synchronization may also allow for iterative interactions with the strategy and operations models for refinement. A solution design module may also be included, providing a tool that allows for further refinement of the costs associated with operational elements in the operations model, to provide for more accurate projections. Further, a process measurement module may also be included, providing a tool that checks value with a greater degree of granularity to ensure that the operational processes of the entity can actually be modified in a way that is capable of delivering the projected value benefit to the entity. A consequence management module may also be included, providing a tool that, in the event that execution control detects a deviation from projected performance, projects the consequences if such a deviation continues. Additionally, a correction management module may be included, providing a tool that allows for recordation of any steps and resources used to address any deviation, thereby building a record of possible solutions for specific problems which may serve as a toolbox whenever future problems arise. It should naturally be understood that in some embodiments one or more of the features described in one module may be incorporated into another module (such that the number of modules is relative, so long as the features and functions are being performed). When some or all of these modules are used together, they can be cross-linked and/or used in a synergistic way, and may also be used iteratively (and in no particular order) to refine corporate strategy in an attempt to accomplish the overarching corporate goals.

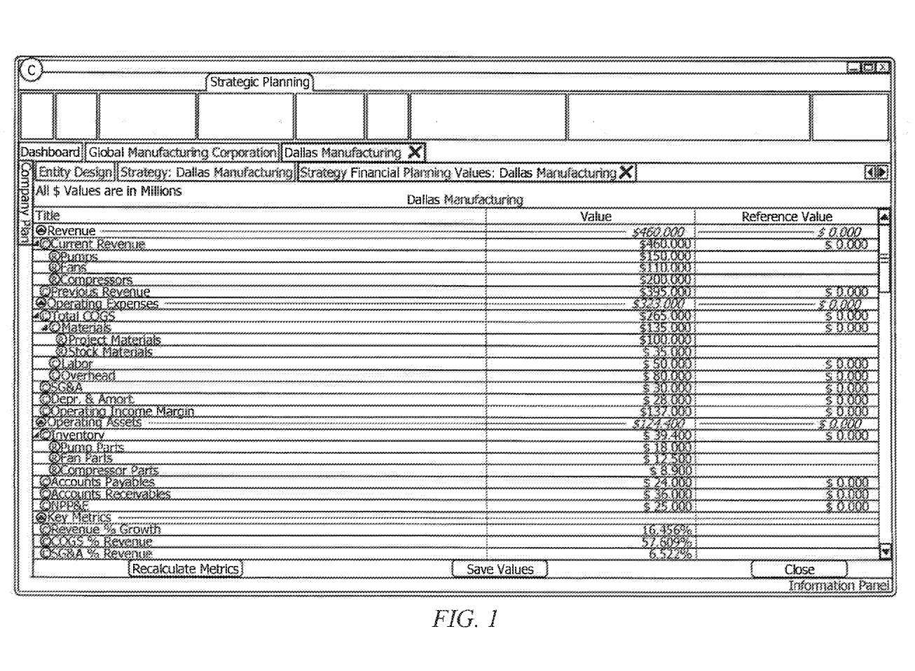

In practice, the modules could be used as part of a method for developing and tracking implementation of an overall corporate strategy model. In one embodiment of such a method, a database would be populated with reference run-rate data of the entity at issue (i.e. the entity that is using the computer model). Such reference data may include standard financial data collected by businesses to track aspects of the business, and typically would include data relating to the categories set forth in the IFRS and GAAP standards for financial reporting. By way of example, the run-rate database of one embodiment might have data categories that track those shown in FIG. 1 (including by way of example, Current Revenue, Previous Revenue, Total COGS (Cost of Goods Sold), SG&A (selling, general, and administrative expenses), Inventory, etc.). For each category of financial data in the database, a corresponding value would also be included. Typically, the value would be based on historical data of the entity, previously gathered and/or reported by the entity for a designated time period. This reference run-rate data may serve as a benchmark of past performance, allowing for projections that may be used in planning and in evaluating results.

A strategy model may then be developed and assessed using a computerized strategy module. In an embodiment of the invention, the strategy would be built by having a user (typically the corporate deciders atop the entity, such as a CEO and/or CFO, by way of non-exclusive example) enter/set business goal(s) and then perform value assessment of the goal(s) by estimating the value that they expect to achieve by implementing the entered goal(s). The goal(s) and value assessment would be saved in a computer accessible medium (such as a database or some portion of a database, by way of non-exclusive example). While the goal(s) may be entirely user defined (allowing for complete customization), preferably the user would select one or more goal elements from a pre-defined menu/list, and the pre-defined list may have a hierarchical structure in which primary elements are sub-divided into secondary elements (that relate to the parent primary element), and so on (with as many levels provided as might be desired).

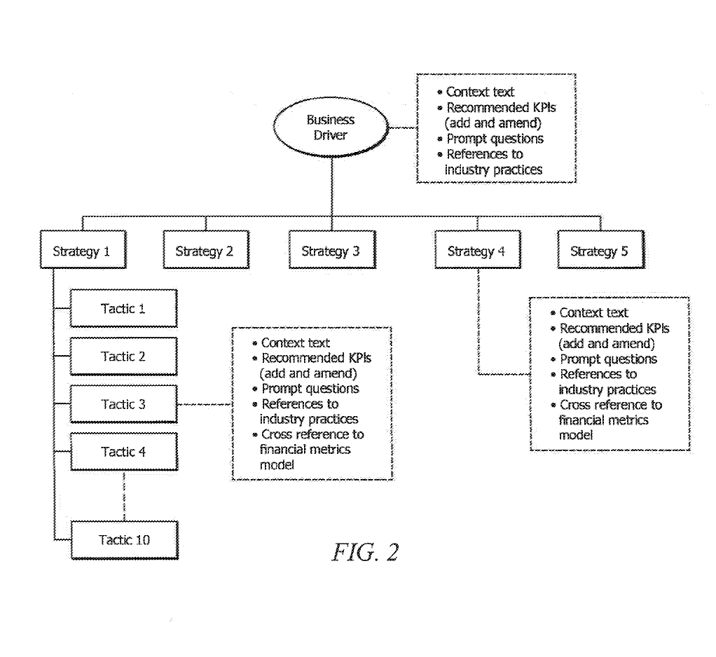

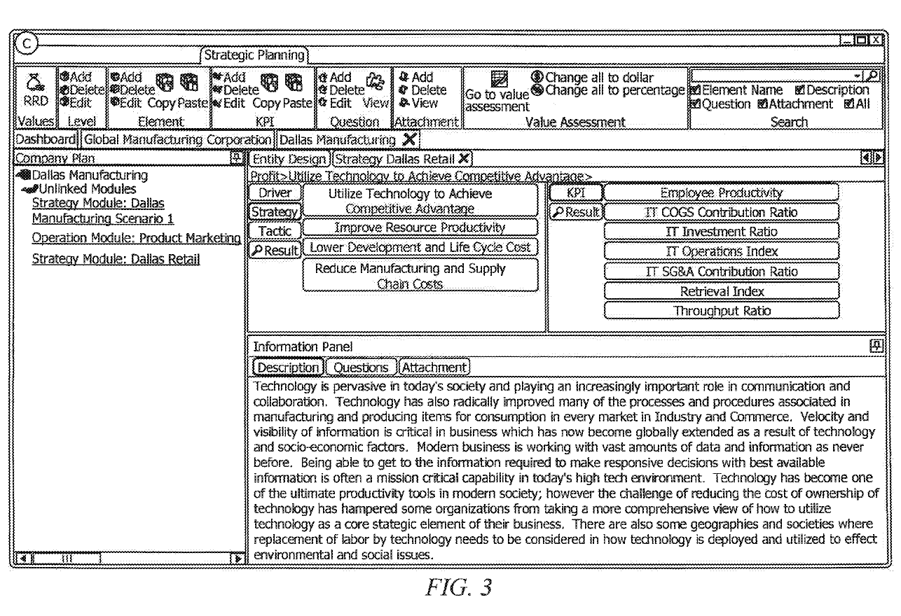

In the embodiment shown in FIGS. 2 and 3, the elements would be selected from a hierarchical structure which comprises business driver elements at the top tier. The business driver elements relate to the ultimate objective of the entity (i.e. what is the entity trying to accomplish as its bottom line goal for the business strategy?). The second tier of the embodiment shown in FIGS. 2 and 3 would include strategy elements that relate to specific ways to achieve the selected business driver (i.e. how may the entity strategically accomplish the selected goal set forth by the selected business driver?). And in the embodiment shown in FIGS. 2 and 3, there is an optional third tier of tactic elements associated with any selected strategy elements (from tier two). The tactic elements would provide a further level of granularity regarding ways to achieve the goal (and would break-down the strategy element into sub-elements that would contribute to the selected strategy). It should be understood that terminology such as business driver, strategy, and tactic are merely illustrative, and other terminology could be used to label such levels of elements within a hierarchical structure.

So in the embodiment shown in FIG. 3, the user would first be presented with a list/menu of pre-defined business drivers (typically stored in a strategy element database within the computerized framework) and would first select one or more business driver elements from the list to include in the strategy model (typically selecting only one, based on what is most important to their business, although alternatively more than one business driver could be used). In the embodiment of FIG. 3, the pre-defined business driver elements in the menu comprise profit and growth. Upon selecting a business driver element, the user would be provided with a second list/menu of pre-defined strategies (typically stored within the strategy element database) that are related to accomplishing the selected business driver. The user would then select one or more strategy elements from the strategy list to include in the strategy model. And for each strategy element selected, the user would have the option to select one or more related tactic elements from a pre-defined list/menu (typically stored within the strategy element database) of tactics related to the selected strategy element. The user could then select one or more tactic element to include in the strategy model. So, in this embodiment, each business driver element has associated strategy elements that are linked to it, and each strategy element has associated tactic elements that are linked to it. These sorts of links would allow for roll-up of value assessment later, since related tactic values may be rolled-up to the strategy level, and various strategies may then be rolled up to tabulate the total value associated with the strategy goal (as defined by the selected business driver).

A user may build up a strategy model within the computerized framework shown in FIG. 3 by selecting a business driver element to add to the model, and then selecting one or more related strategy elements and possibly selecting one or more tactic elements related to each selected strategy element. The selected elements are added to the computerized strategy model (and typically saved to the model database). In this way, the strategy model may be built up using the tools provided within the computerized framework, and the computerized strategy model can be saved onto a computer-accessible medium (such as a database) for later use.

While not required, the embodiment of FIG. 3 also includes Key Performance Indicators (KPI) associated with each strategy and/or tactic element. A KPI represents a measurable or metric considered important in evaluating a particular strategy or tactic element (by measuring its performance). The KPI should reflect the entity's goal (as defined by the related strategy/tactic), be key to its success, and be quantifiable. In the embodiment of FIG. 3, each strategy and/or tactic would have a list/menu of KPI that might be relevant to measuring the selected strategy or tactic element. When the user selects a strategy/tactic element to add to the model, the user may then select which one or more associated KPI they wish to use to measure the selected strategy/tactic element that has been added to the strategy model, thereby also adding it to the model. It should be noted that the KPI selected and saved into the strategy model in this fashion are linked to the relevant strategy/tactic element in the model.

So a user interacts with the strategy module within the computerized framework to build the strategy model up, and in the embodiment shown in FIG. 3, the model is built up by selecting elements from the hierarchical menu structure. Selected elements are saved in the model database as part of the strategy model, and there are links within the strategy model defining the associations between related business driver-strategy-tactics-KPI. In some embodiments, the strategy module may also include additional tools to assist the user during construction of the strategy model. By way of example, there may be descriptive text (explaining the elements, for example), questions (for spurring user choice), and/or attachments, which may be linked to each element and saved as part of the strategy model, for example, in the model database. Additionally, the user may be allowed to add notes and attachments (linked to specific elements) to the strategy model, for future reference.

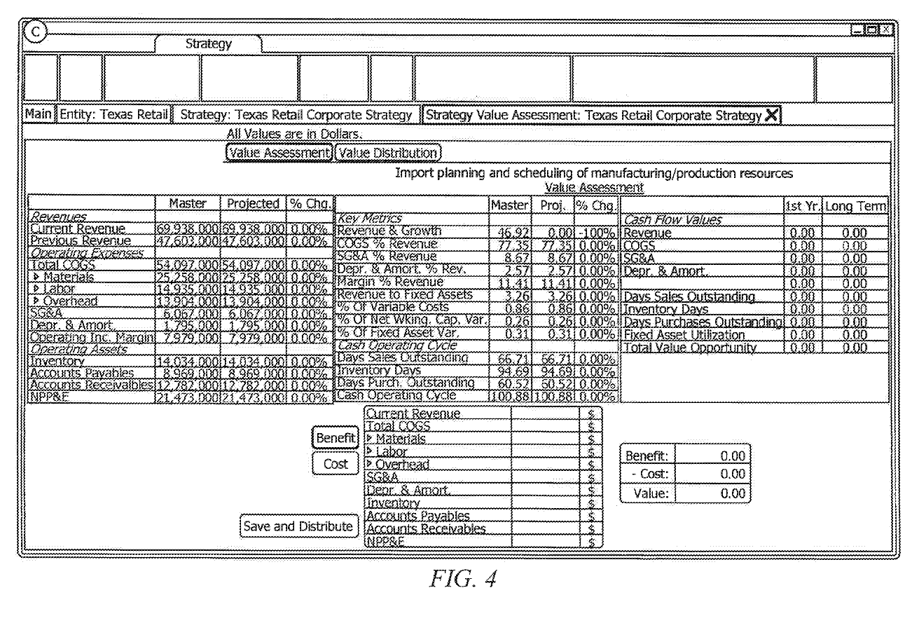

Once the strategy model has been built, its value can be assessed (in order to preliminarily evaluate the financial impact of proposed business strategy) within the strategy module. Value assessment may take place at the strategy level or at the tactic level (depending on whether the user wishes to employ a top-down or bottom-up approach). In the embodiment shown in FIG. 4, the value may be assessed using the reference run-rate data as a benchmark, and allowing the user to predict (using business experience and/or gut instinct) how much of an improvement the particular element of the strategy model will have on one or more of the run-rate data categories.

So for each element in the strategy model, the user may set the amount that they believe this strategy or tactic element will affect specific run-rate data categories (either in terms of percentages or actual currency). The run-rate data categories are typically related through known calculations (since they are standard financial metrics defined by GAAP or International Finance Reporting Standards). In other words, each category of run-rate data is related to one or more of the other categories of run-rate data in pre-defined ways, such that changes to one category would result in corresponding changes in one or more other categories. Thus, the strategy model can calculate a projection by refiguring the other run-rate data categories using the historic reference data as a benchmark and the estimated effect entered by the user (related to the specific element of the strategy model). This allows for a projection of the financial impact of each element of the strategy model, which may then be aggregated (rolled up) to determine the overall financial impact of the strategy model as a whole. The refigured run-rate data projection can also be condensed into the amount of benefit and cost associated with the element, and by subtracting cost from benefit, the overall value of the element can be assessed. These values (associated with each element in the model) can be rolled up to determine the total assessed value of the strategy model.

In the embodiment shown in FIG. 4, each pre-defined tactic and strategy element within the strategy module has been associated (and pre-linked) with the relevant run-rate data category. Thus, when a user conducts value assessment on a specific tactic or strategy element within its strategy model, the relevant run-rate category for consideration will be noted (by being highlighted or bolded, by way of non-exclusive example) to guide the user's projection (so that the user can quickly identify the correct run-rate category to consider and modify). Additionally, the user may access related graphical displays showing, by way of non-exclusive example, the financial run-rate projection, and/or the cash flow projection.

If a bottom-up approach is taken, the user would perform value assessment for each element at the tactic level, and these values could then be rolled up (either automatically or by choice of the user) to determine the overall value of the related strategy element. Similarly, the value of all strategies could then be automatically rolled up to determine the total value of the entire strategy model. On the other hand, if a top-down approach is taken, the user would perform value assessment at the strategy level first and then at the tactic level, and would then be able to compare the two and to iteratively interact with each in order to approximately equalize the value. Such an iterative approach may serve as a tool for users to refine their projections.

Once value assessment is completed and saved to the database as part of the strategy model, the user may have the option to distribute the value over time, and may also graphically display the distributed value. Such optional distribution of the projected value associated with the strategy model may be useful to inform business decisions, and may later be useful if synchronization (by providing another comparison between the strategic and operational models) and/or execution control (by providing a comparison to the projection curve) is performed.

So, using the strategy module, the user may build up the elements of a strategy model and assign an assessed (estimated) value to the strategy model. In the embodiment of FIG. 3, the strategy is built by selecting pre-defined elements from a hierarchical menu, to aid in guiding the user's thought process (although in other embodiments the model could also be built from scratch by the user, who would define and set the elements (and their associations/links) on their own, and/or built by modifying pre-defined elements and/or adding additional user-defined elements (and their related links) to the model). In the embodiment of FIG. 4, value is assessed by estimating the impact of the element of the strategy model to the related run-rate data category, and then recalculating the remaining run-rate categories based on those estimates to arrive at the assessed value of each element. So after interacting with the computerized strategy module, the user should be able to construct a computerized strategy model within a database having various elements (which may be inter-related and may have related KPI associated therewith), and to calculate the assessed value of the strategy model (by rolling up the associated value assessed for the elements of the model, for example). The user may build as many of these strategy models as they wish, allowing simulations of different strategic scenarios. Typically, only one strategy model is ultimately selected, and it would be the master strategy model that would be used in conjunction with an operations model to implement the overall strategy.

Once the strategy model has been created, the user may interact with the operations module to develop an operations model (that is typically guided by the strategy model). In an embodiment of the invention, the operations model would be built by having a user (typically one or more operations level managers, by way of non-exclusive example) enter/set operational element(s) (such as listing the various operations they feel are related to each strategic element) and then setting benefit calculations related to each operational element designed to provide an operational estimate of the value that they expect to achieve by implementing each operational element. The benefit calculation(s) are designed to provide a value projection with increased granularity, being based on the reference run-rate data. The operational element(s) and benefit calculations would be saved in a computer accessible medium (such as a database or some portion of a database, by way of non-exclusive example). While the operational element(s) may be entirely user defined (allowing for complete customization), preferably the user would select one or more operational elements from a pre-defined list/menu, and the pre-defined list may have a hierarchical structure (similar to that discussed above for the strategy model) in which primary elements are sub-divided into secondary elements, and so on (with as many levels provided as might be desired). And preferably, the operations users would have access to the strategy model (with the operations module displaying the strategy model saved in the model database), so that they may view it and use it to guide their thinking as they construct an operations model intended to implement the overall corporate strategy.

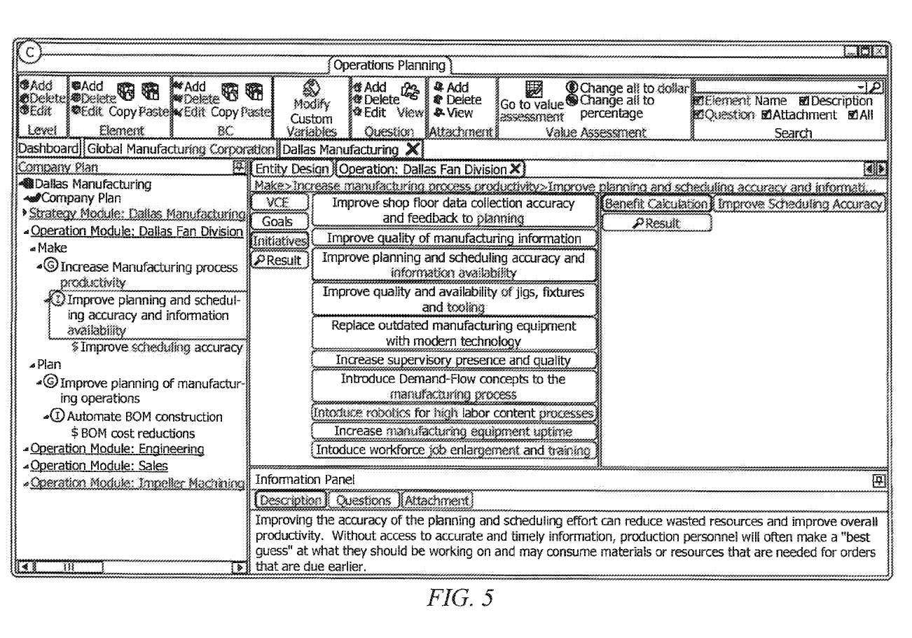

In the embodiment shown in FIG. 5, the elements would be selected from a hierarchical structure which comprises value chain elements at the top tier. Value chain elements (VCE) relate to the type of elements that are associated with the operational environment of the business. In other words, VCEs generally describe what is important to implementing the business operations. The second tier of the embodiment shown in FIG. 5 would include goal elements that relate to specific operational goals related to the chosen VCE (i.e. how the VCE are supported in the business). And in the embodiment shown in FIG. 5, there is an optional third tier of business initiatives associated with any selected goal elements (from tier two of the operations module). The business initiative elements would provide a further level of granularity regarding ways to achieve the goal (and would break-down the goal element into sub-elements that would contribute to the selected goal). The specific hierarchical structure would depend on the type of industry or functional area at issue at the operational level (and various operations models might be needed if the entity's business spans several different types of industries and/or functional areas, with all such operations models relating hack to the overall business strategy). So the user may first have to select the type of industry, in order to access the appropriate model menus. The example shown in FIG. 5 relates to operations within a manufacturing industry, for example.

So in the embodiment shown in FIG. 5, the user would first select the type of business at issue, in order to bring up the relevant pre-built model structure. Then, the user would be presented with a list/menu of pre-defined VCE (typically stored in an operation element database within the computerized framework) and would first select a VCE element from the list to include in the operations model. The user may select as many VCE elements as they feel are necessary to reflect the operational side of their business. Upon selecting a VCE, the user would be provided, with a second list/menu of pre-defined goal elements (typically stored within an operation element database) that are related to the selected VCE. The user would then select one or more goal elements from the list to include in the operations model. And for each goal element selected, the user would have the option to select one or more related business initiative elements from a pre-defined list/menu (typically stored within an operation element database) of business initiatives related to the selected goal element. The user could then select one or more business initiative elements to include in the operations model. So in this embodiment, ent, each VCE has associated goal elements that are linked to it, and each goal element has associated business initiative elements that are linked to it. These links allow for roll up of the value estimated by the benefit calculations later, since the related business initiative values may be rolled up to the goal level, and the various goals may then be rolled up to tabulate the total estimated value associated with the operations model. It should also be noted that in an embodiment, each operations element would be associated with (linked to) a strategy element that it is targeted towards accomplishing.

A user may build up an operations model within the computerized framework shown in FIG. 5 by first selecting the type of industry of the business to be modeled (i.e. selecting the overall model type, since model elements at the operational level will vary depending upon the type of industry), selecting VCE element(s) to add to the model, and then selecting one or more related goal elements (related to each selected VCE) and possibly selecting one or more business initiative elements related to each selected goal element. The selected elements are added to the computerized operations model (and typically saved to the model database). In this way, the content of the operations model may be built up using the tools provided within the computerized framework.

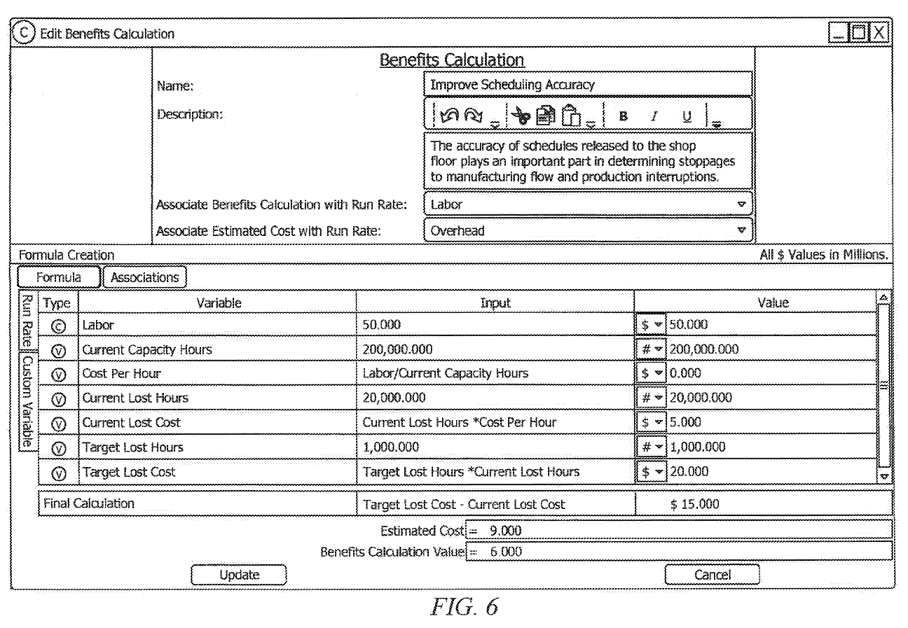

Each goal and/or business initiative would typically have a benefit calculation associated with it, allowing for determination of the operational value of the element. A benefit calculation is defined to provide a practical measurement of the element at issue, establishing the expected derived benefit from the proposed change to the operational process. Benefit calculations are formulas that typically include variables tied to the run-rate data, and are typically based on business experience relating financial data and target change in a way that provides a measurement metric for the operations element. In some embodiments, the user may define (or amend) these benefit calculations themselves (constructing the calculation using a tool kit that provides for variables linked to the reference run-rate data). By way of example, see FIG. 6. In the embodiment shown in FIG. 5, however, each goal and/or business initiative element has a list/menu of one or more pre-defined benefit calculations that might be associated with it. The user may then select which one or more benefit calculations they wish to use to measure the selected goal/business initiative element added to the operations model, thereby adding it to the model as well.

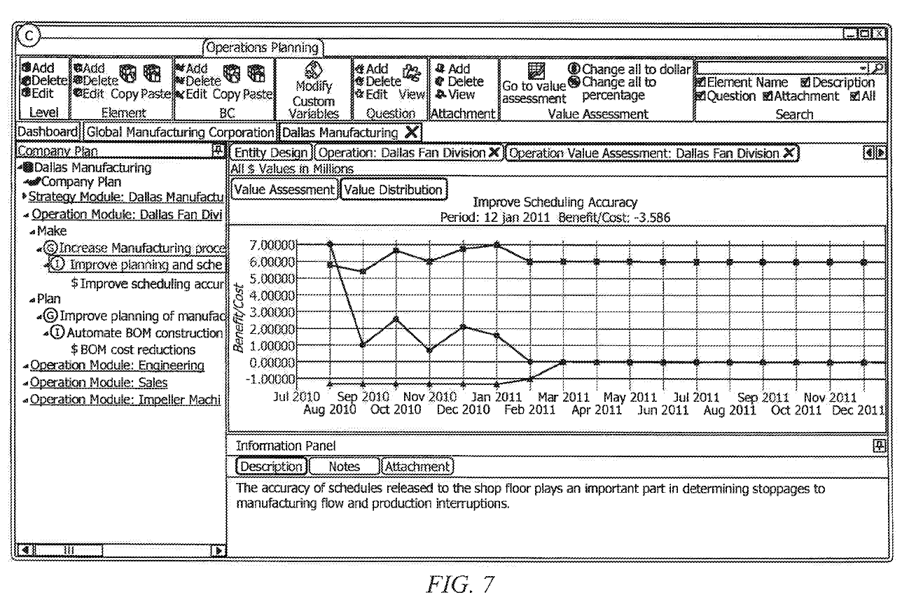

Once the user has selected a benefit calculation in the embodiment of FIG. 5, the benefit calculation interacts with the run-rate database to return an estimated operational value. Typically this is done using the historic run-rate data to fill-in the variables in the benefit calculation to calculate a projected benefit, and allowing the user to input an estimated cost for achieving this benefit. Then, the value can be determined by subtracting the estimated cost from the projected benefit, to arrive at a projected value. The cost and benefit (and thus the value, which is the difference between benefit and cost) estimated by the benefit calculation for a particular element of the operations model can then be distributed over time. This provides a projection curve for estimating the value of implementing the business strategy over time. In the embodiment shown in FIG. 7, the distribution may be stored and displayed graphically.

So the users interact with the operations module within the computerized framework to build the operations model up, and in the embodiment shown in FIG. 5, the model is built up by selecting elements from the hierarchical menu structure. Again, the module may contain descriptions, questions, and/or attachments designed to assist the user in building an effective model, and the user may be allowed to save notes and/or attachments to the model. Selected elements are saved in the model database as part of the operations model, and there are links within the operations model defining related VCE, goals, business initiatives, and benefit calculations. The benefit calculations provide a projection regarding the value that may be achieved by each goal and/or business initiative element of the operations model, which may be rolled up to determine the overall financial impact (projected value) of the operations model as a whole.

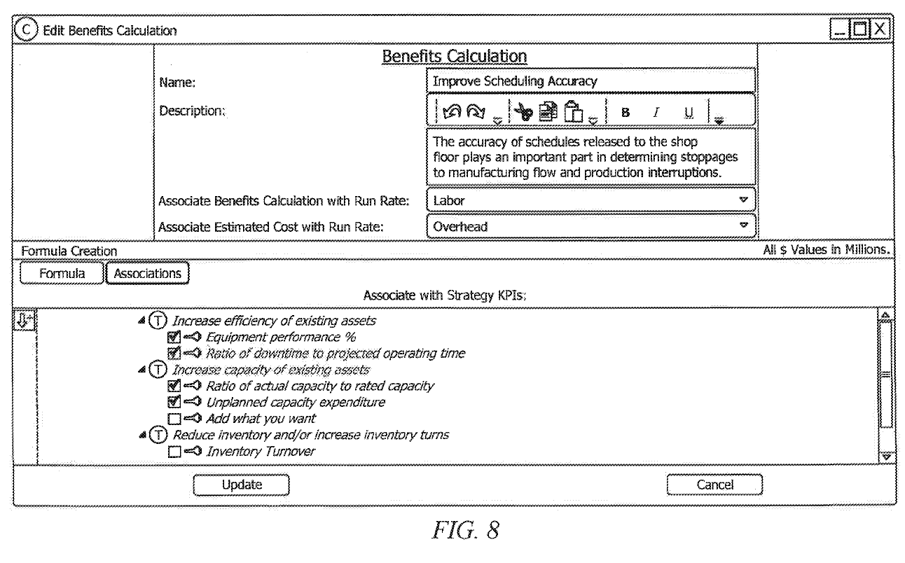

In the embodiment of FIG. 5, each goal element in the operations module is linked to one or more corresponding strategy elements in the strategy module, each business initiative in the operations module is linked to one or more corresponding tactic and/or strategy elements in the strategy module, and each benefit calculation in the operations module is linked to one or more corresponding KPI in the strategy module (assuming KPI are used). This cross-linkage between elements of the operations module and operations of the strategy module may be useful if synchronization is to be employed later (since it allows for quick reference to see which available operations elements that could possibly relate to a specific element of the strategy model have actually been added into the operations model, and which have not been). In the embodiment shown in FIG. 5 (which uses pre-defined elements that the user may select from a list/menu), these links are pre-defined. In other embodiments in which the user defines the elements themselves, however, the user may also define the links between elements of the operations module and the strategy module (with such link information being stored in the association database). By way of example, FIG. 8 provides an example of a tool for defining the links between sample KPI and sample benefit calculations.

It is also possible that an embodiment could use the pre-defined links between strategy model elements and operational elements so that when the user interacts with the operations module, the list of pre-defined operational elements available for selection by the user would be limited to those that are related to strategy elements that have already been selected and added into the strategy model (or alternatively, those related operational elements could merely be highlighted to provide guidance to the operations users, without restricting their choices). This type of approach (using the links between the strategy model elements and the operational elements) might allow for automatic synchronization during the building of the operations model, reducing the need for a separate synchronization step.

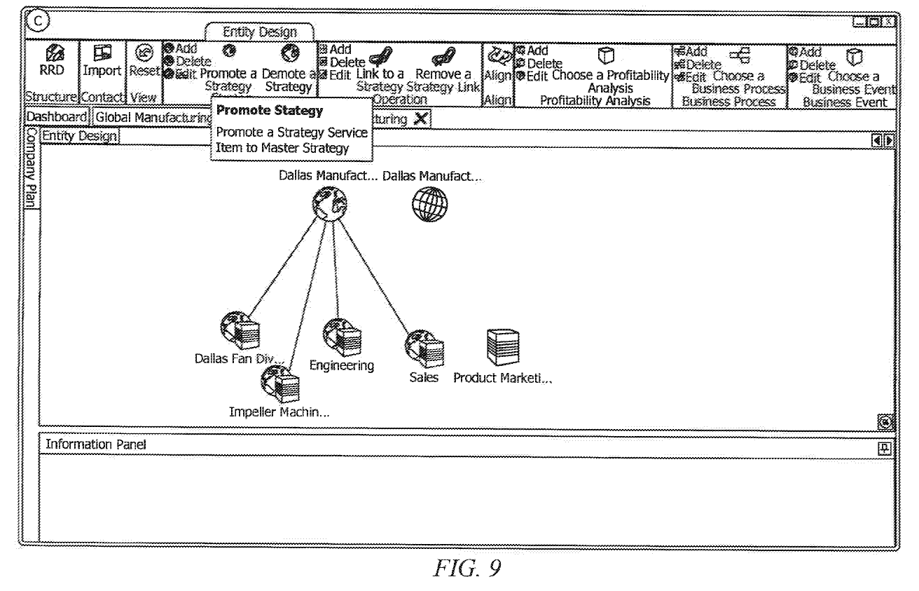

More than one operations model may be built if the entity has multiple operational elements (such as retail and manufacturing, by way of non-exclusive example). Each operations model could be built up as described above. All operations models would typically be tied to the selected strategy model (which might be termed a master strategy model), so that the organization as a whole is aligned to achieve the overall corporate strategy. And if the entity decided to switch to an alternate strategy model, the operations model(s) could be reassigned (such that elements in the operations model(s) could be linked to elements within the new strategy model). Alternatively, for example, the entity could create one or more new operations models linked to the new strategy model. The opportunity to switch between strategic models allows dynamic switching of strategic associations and value assessments between a new set of models. FIG. 9 illustrates such an embodiment.

So in practice, the entity might first construct a strategy model, and then use that strategy model as a guide to construct an operations model. The operations model projects the value of implementing the strategy and distributes it over time. Thus, the output of the operations model is a projection curve that plots the expected value of implementing the strategy over time. The entity may use this projection in its business planning. The execution control module may then be used to evaluate whether the actual implementation of the strategy is on track with the projection, effectively monitoring the real-world effect on the entity's business as the strategy is implemented. In this way, execution control completes a closed loop design by providing the capability for users to determine (via interaction with the host database(s) storing current updated financial data, for example) if the projections are (or are not) being realized (based on how effectively the real world current data tracks the operations model value projection curve).

Execution control typically translates the benefit calculations in the operations model into execution control indicators that enable monitoring of the current value compared to the benchmark provided by the operations model. In other words, an execution control indicator (ECI) is defined within the execution control module and linked for each benefit calculation. ECI will typically employ the same calculation constructed for the related/linked benefit calculation, but will replace the historical reference run-rate data used to attribute values to the variables of the benefit calculation with the corresponding actual currently measured data (which can be extracted from the entity's host database(s) or can be entered periodically into a database associated with the execution control module). The benchmark is the value projection curve from the operations model (in which the benefit/cost has been assessed in the operations model using historic reference run-rate data and distributed over time). Within the execution control module, the user may interact with this projection curve to set limits (regarding the acceptable variance from the projection before a warning notification is generated) and to set the frequency with which execution control indicators will be compared to the projection. If the ECI returns a value that is outside the limits (i.e. that is more than the set limit(s) from the projection curve), then a warning may be automatically generated and sent to appropriate personnel. In some embodiments, such ECI deviation might also be viewed on an enterprise management module (dashboard) operable to show a hierarchical structure of connected units within an n-tier organization, or a global map view showing the units and their global geographic location to one another, or in a consequence manager module.

It should be noted that at least some of the data used in ECI might in some embodiments be collected, retrieved, and/or transmitted by sensors. For example, programmable logic controller sensors could be used at various physical locations to measure data for ECI. The execution control module might also be set to measure and/or evaluate other non-value-based measurables. For example, event-based measurables such as KPI, run rate variables, or custom variables could be used, with warnings being generated if some key measurable is outside its limits. For instance, sensors could monitor operation and performance of machines (such as various machines in an automated assembly line, for example), or could even measure human activity (such as the number of customers entering a retail store, for example). The sensor data would then typically be transmitted or input into a database for use evaluating performance in comparison to projections.

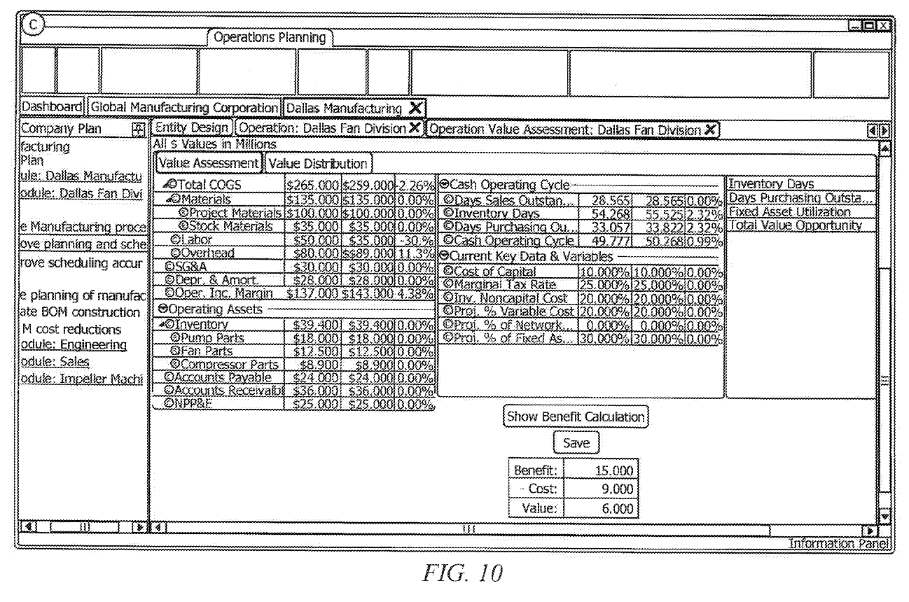

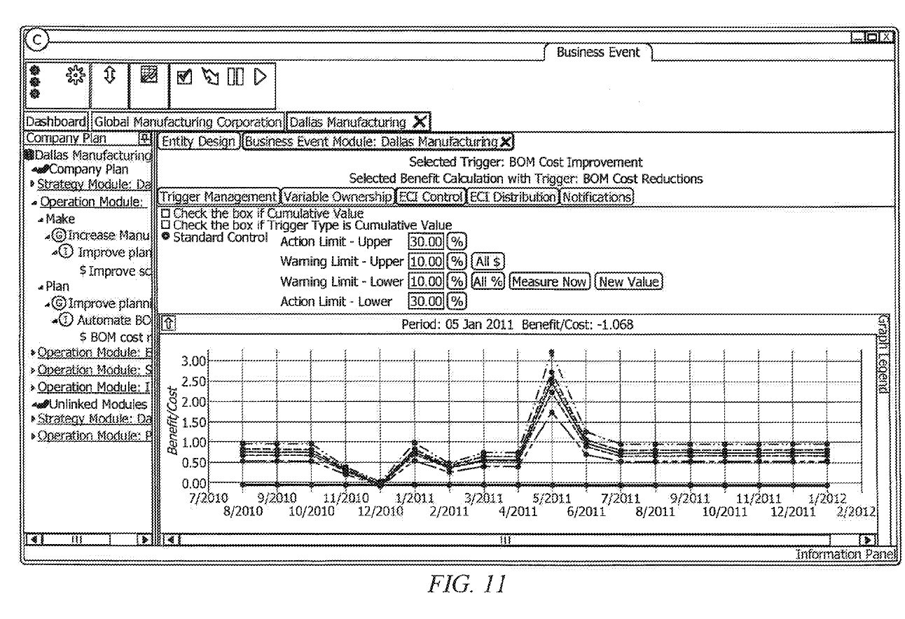

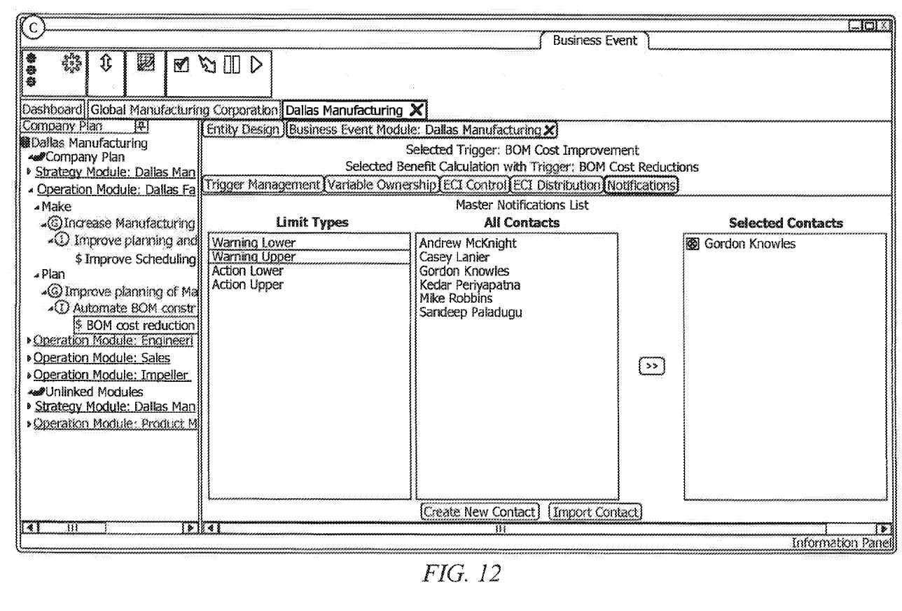

To set up the execution control module for monitoring as shown in the embodiment of FIG. 10, the user would first import the benefit calculations from the operations model and link the run-rate variables in each calculation to the appropriate corresponding database entry in the entity's host database relating to the current measured value of that variable. Importation could be automated in some embodiments. The user would also set one or more triggers that would determine when data will be retrieved from the host database to calculate ECI. Typically, the trigger would be a time increment, such as monthly. The user would also set the limits (which provide the allowable tolerance of deviation from the projection prior to warning), which could be set as a percentage or amount above and/or below the projection curve (from the operations model). The limits might then be displayed graphically along with the projection curve (as in FIG. 11). The user would also set alert notifications for each particular ECI by entering one or more contact personnel who should be warned in the event that a specific ECI is outside the acceptable limits, along with their contact information (as shown in the embodiment of FIG. 12).

Once the execution control module has been set up by the entity, it is designed to monitor events automatically and to transmit automated warning notices. So, if a particular ECI comes back (when current data is retrieved according to the set trigger and plugged into the ECI/benefit calculation) outside the set limits, the EC″ module may send an automated warning notice to the designated contact personnel using the contact information. The warning notification could be automatically transmitted via e-mail or could be transmitted as a text message to the user's cell phone, by way of non-exclusive example, providing instant notice. In addition to transmitting a notice, in the embodiment of FIG. 12, the warning notice may identify the particular ECI/benefit calculation that is outside its limits, and may use the associations/linkages (between ECI/benefit calculations, business processes, and elements in the model) to identify the related elements of the operations and strategy models that are impacted, to provide guidance as to the areas that need to be addressed to bring the strategy implementation back on course. Associations set up in the database may also allow for consequential association between ECI in other units within an n-tier organization. So for example, an ECI in a first unit in one country showing performance deviation (which may have a ripple effect throughout the supply chain of physical goods) might result in an alert to other units which may be affected. ECI which are associated with business processes in a unit may provide warning of consequential performance deviation of ECI attached to different processes in units anywhere in the entity organization. These types of associations may provide the basis for predictive consequences in performance of strategic and operations plans within an n-tier organization. In some embodiments, the warning notice may also calculate and display the financial consequences of the out-of-control ECI (possibly using a consequence management module, as discussed in more detail below). In an exemplary embodiment, this projection of financial consequences would be based on the known relationship between the various run-rate entries. Thus, the integrated and linked nature of the modules can provide a great deal of useful information that allows users to quickly identify the problem and the possible solutions to get the entity back on course according to the overall corporate strategy.

In an embodiment of the invention, the execution control module could also include predictive analysis. Predictive analysis would use trending information to extrapolate if and when the ECI is likely to move outside the limits, so that early warning could be sent before the ECI actually exceeds the limits. By way of example, linear or exponential extrapolation techniques could be applied to the last two or more ECI results to predict if the ECI is trending in a way that will lead to a problem. This option would provide another level of warning that could prove helpful in keeping the entity on track with its goals.

While each of the strategy, operations, and execution control modules could have independent applications, by integrating these three modules, an entity may be better able to establish a unified corporate strategy that can be effectively implemented throughout the organization. It also provides for a closed loop system in which the strategy may be defined, implemented, monitored, and refined (perhaps iteratively), especially with the addition of optional consequence and correction management modules, in a way that should improve the running of the entity's business operations.

In addition, there are other optional modules that could also be used to further refine the process (in an attempt to provide better value projections and/or to improve the computer models, by way of non-exclusive example). Although certainly not required, an entity could use any or all of these additional optional modules to try to improve the process further. A brief discussion of embodiments of such optional modules follows.

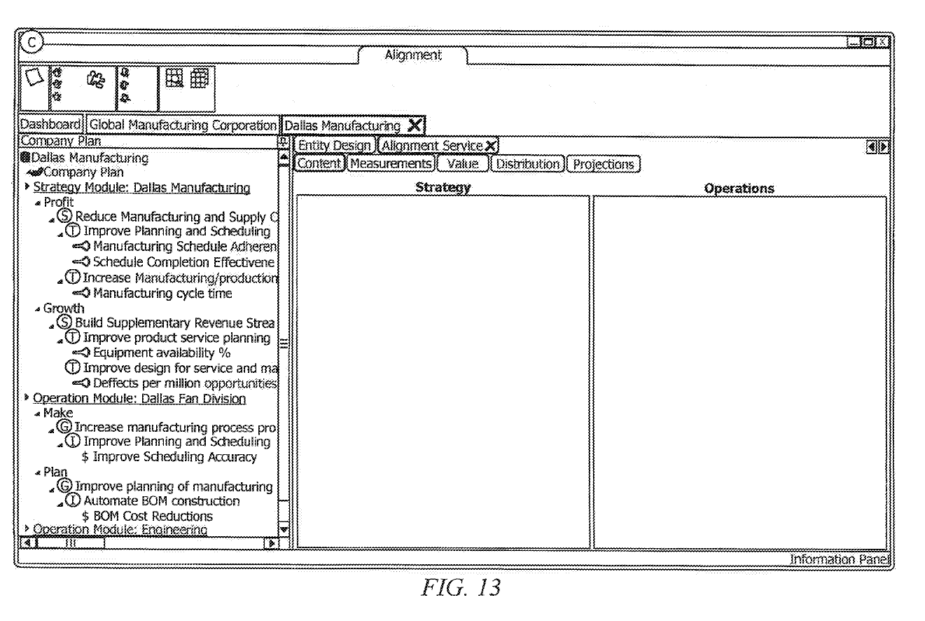

After constructing a strategy model and an operations model, the users may then attempt to synchronize the models to ensure that the strategy model and the operations model are roughly aligned towards the same goals. This may be accomplished using the embodiment of the synchronization module of FIG. 13, which allows for side-by-side comparison of the strategy and operations elements. In the embodiment of FIG. 13, the synchronization module provides five different views of this side-by-side comparison, with each view providing tools that may help users evaluate the degree of alignment between strategy and operations models.

The first view compares the content of the strategy model to that of the operations model. So, when using the content view, the user may select an element of the strategy model for consideration in the strategy window (perhaps by clicking or dragging it into the strategy window, by way of non-exclusive example). When a strategy element is selected, all possible operations elements in the operations module that are related/linked to that strategy element in the strategy module may be displayed in the operations window, with the operations window also noting those related operations elements that have been included in the operations model and those that are not included in the operations model. In a specific embodiment, these links are retrieved from the association table/database.

In the embodiment shown in FIG. 13, the related operations elements that have been added into the operations model would be highlighted, while the remaining potentially relevant operations elements (that were not selected for inclusion in the operations model) would not be highlighted. Any other designation (such as an asterisk or bolding or a different color, by way of nonexclusive example) could be used to denote the difference between selected and unselected operations elements. Such a display allows users to quickly identify the degree of alignment between the related elements of the operations and strategy models, and may provoke discussion between the business deciders (who developed the strategy model) and the operations managers (who developed the operations model) about the decisions made in constructing the operations model, the reality of the strategy when being implemented, and/or possible ways to amend and improve the operations and/or strategy model.

This comparison can be performed for each element of the strategy model. This allows for the models to be iteratively adjusted to bring the overall strategy and operations models into better alignment (to help the entire organization to follow through on a unified corporate strategy). It should be noted that in the embodiment of FIG. 13, the strategy and/or operations models may be modified directly at this stage using the interface provided by the synchronization module (which typically interacts with the strategy and/or operations modules to allow for modification of the computer model), and that any modifications will be saved to update the modified version of the model in place of the originally constructed model. For example, in the embodiment Shown in FIG. 13, any unselected operational elements displayed in the operations window (that are related to an element of the strategy model) may be selected and added to the operations model, the assessed value in the strategy model could be amended, and/or the benefit calculation could be amended.

The user may also employ the second view to compare the measurements associated with the strategy and operations models for synchronization. The user may select a KPI from the strategy model for display in the strategy window. Doing so will display (in the display window) all of the benefit calculations in the operations module that are related/linked to that KM in the strategy module (as typically determined by the association database), while designating those that have been selected for the operations model and those that have not. Again, in the embodiment shown in FIG. 13, the related/linked benefit calculations that are included in the operations model will be highlighted, while those that have not been selected for inclusion in the operations model will remain un-highlighted. The user would typically perform this procedure for each element in the strategy model (by selecting and analyzing each element of the strategy model in turn). Again, this comparison allows for discussion and iterative modification of the models.

The user may also employ the value view to compare the projected/assessed value, benefit, and/or costs of elements in the strategy model to the estimates in their associated elements in the operations model. As discussed above, selection of an element of the strategy model for consideration in the strategy window of the synchronization module will automatically populate the strategy window with the value information associated with that strategy element and populate the operations window of the synchronization module with all of the elements (and their associated projected values) from the operations module that are linked to that element in the strategy module. And once again, the operations elements that have been included in the operations model would be designated in a way that distinguishes them from those that have not been selected. And it should be noted that the user might also alternatively begin the synchronization process by picking an operations element from the operations model. This will allow for quick comparison of the value, benefits, and/or costs of the selected strategy element with the related selected operations elements. The user would typically perform this procedure for each element in the strategy model (by selecting and analyzing each element of the strategy model in turn). Again, this comparison allows for discussion and iterative modification of the models.

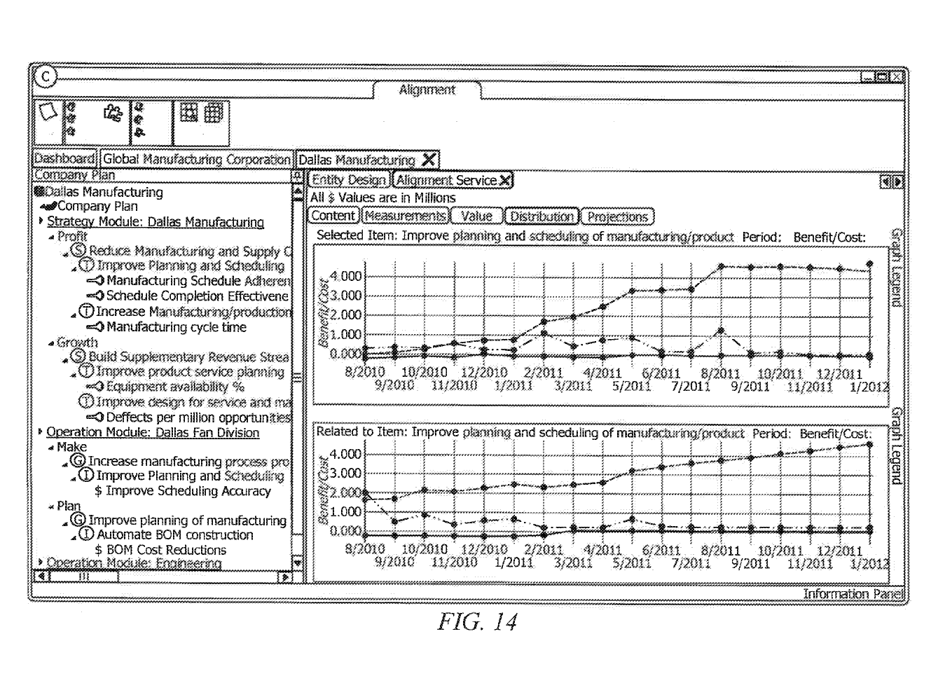

The user may also employ the fourth view, which allows benefit, cost and value distribution previously set in the strategy value assessment associations to be viewed side by side so the potential mismatches in the distribution plans for specific strategy element and its directly associated operational element may be interrogated. This may also extend to a view which displays the distribution for the total value, benefit and cost of a strategy plan directly with the distribution for the total operations plan (see for example FIG. 14).

The user may also employ the fifth view to compare strategy projections to operations projections. When this view is selected, the projected financial metrics and cash flow based on the run-rate data (i.e. the run-rate projections) of the entire strategy model would be shown in the strategy window while those of the entire operations model would be shown in the operations window. This view may provide insight that aids in collaborative efforts to iteratively modify the plans to bring them into better alignment.

By using one or more of the views of such a synchronization module, the users may be able to refine the strategy and operations models (by comparing the two for alignment and iteratively modifying either or both models to bring them into closer alignment) to ensure that the organization as a whole is directed towards a single unified plan (in which the operational plan supports and implements the strategic plan). It may provide the impetus and forum for a discussion between business decision makers and operational managers, who each bring a different perspective and set of skills and experiences that may be useful in refining the overall corporate plan (which includes both the strategy model and the operations model). And this synchronized operations model may be used in conjunction with the execution control module to provide for improved implementation of the strategy (with the updated and modified benefit calculations included in the finalized operations model being used to develop the ECI for the execution control module).

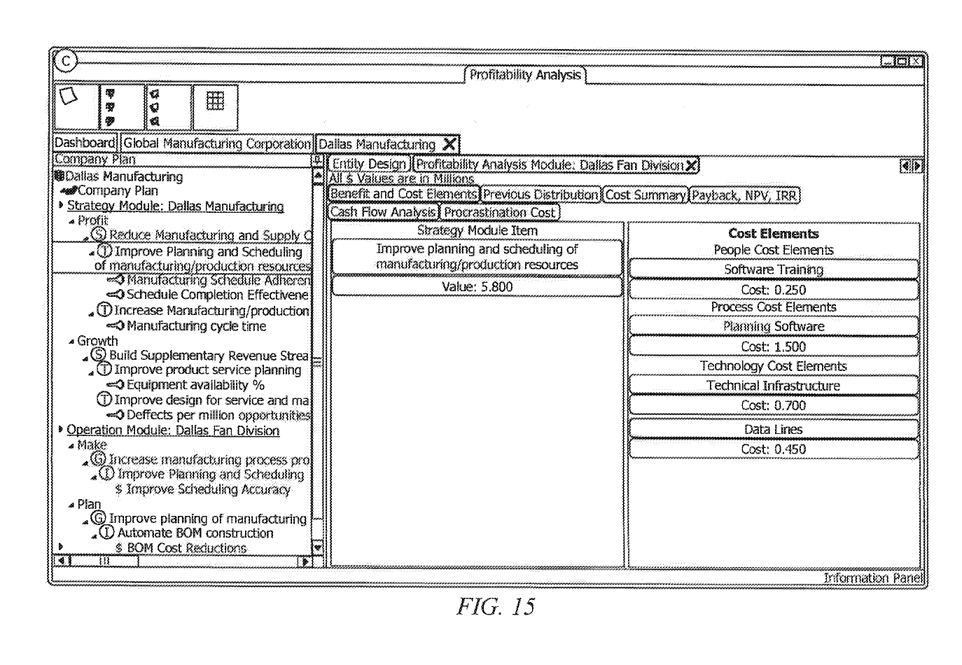

Another optional module that may be used to further refine the process could involve a solution design module. Once an operations model has been constructed, the users may then wish to employ a more refined analysis of the costs likely to be associated with the elements of the operations model, as a check to ensure that the operations model may realistically be executed in the real world. This may be accomplished using a solution design module, such as the embodiment shown in FIG. 15 which allows for costs to be analyzed with greater granularity, typically based on more tangible data such as cost quotes related to the type of investments (i.e. the corporate resources) that operationally will be required by the entity to implement the strategy.

In the embodiment of FIG. 15, the solution design module provides tools to assist the user in detailing the investment (resources) that each operational element will require (to create a list of resources for each operations element), along with its costs. Once this has been completed, the solution design module also provides tools that can allow the user to view the financial consequences of the analysis, as well as perhaps analyzing the cost associated with delays in implementing the operational element (i.e. procrastination costs). So in the embodiment of FIG. 15, the user may first select a particular element of the strategy model to consider using the solution design module. The benefit assessed to the selected operational element would be based on that set in the operations module (since the solution design module is focused on refinement of costs, and does not impact the assessed benefit value). In FIG. 15, a window is provided allowing entry of various cost components associated with implementing the selected operations element (so a user may detail the resources that will need to be allocated for implementation). The user may then construct the costs components by listing the cost elements (for the resources that are needed for the operational element), entering the cost estimate for that cost component, and detailing the time that such costs would likely be incurred.

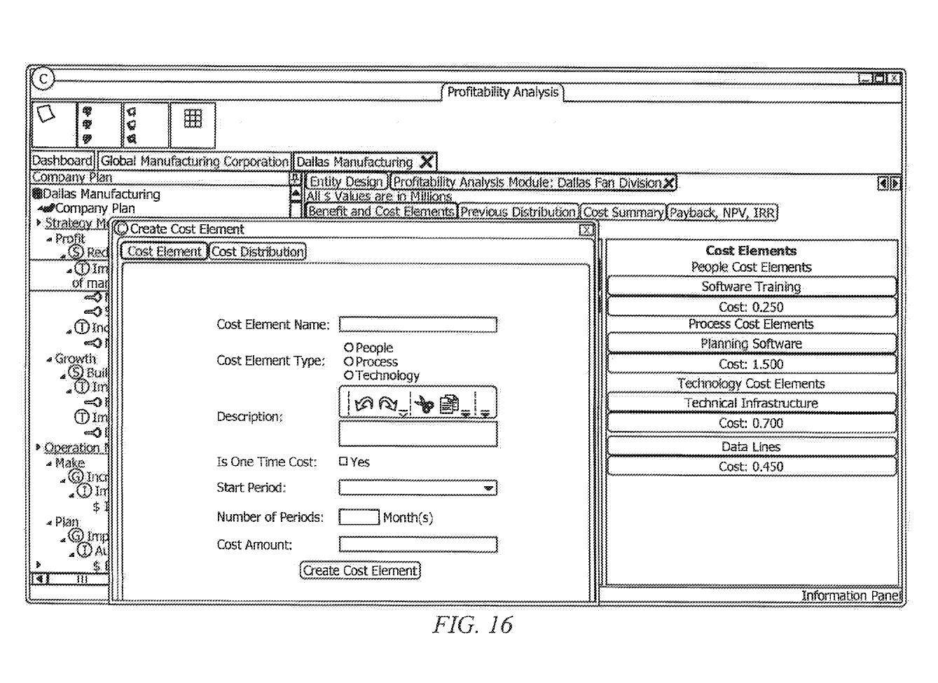

FIG. 16 illustrates an embodiment of a tool that assists in entry of the cost components (which would typically be a pop-up screen linked to the solution design window of FIG. 15). In FIG. 16, the user may name the cost element, select the type of cost element (between people, process, and technology, by way of non-exclusive example), determine if it is a one-time cost or not, set a start period (when the cost will begin to be accrued) and a duration (such as a number of months from the start period), and enter the amount of cost associated with the cost element. The user may also distribute the cost across the set time period. Once the user has entered the required data information to define a cost component (as in FIG. 16), that cost component will be displayed in the cost element window of the solution design module shown in FIG. 15. The user continues creating cost components as needed, until all of the cost components that the user believes are associated with implementing the selected operational element of the operations model have been set.

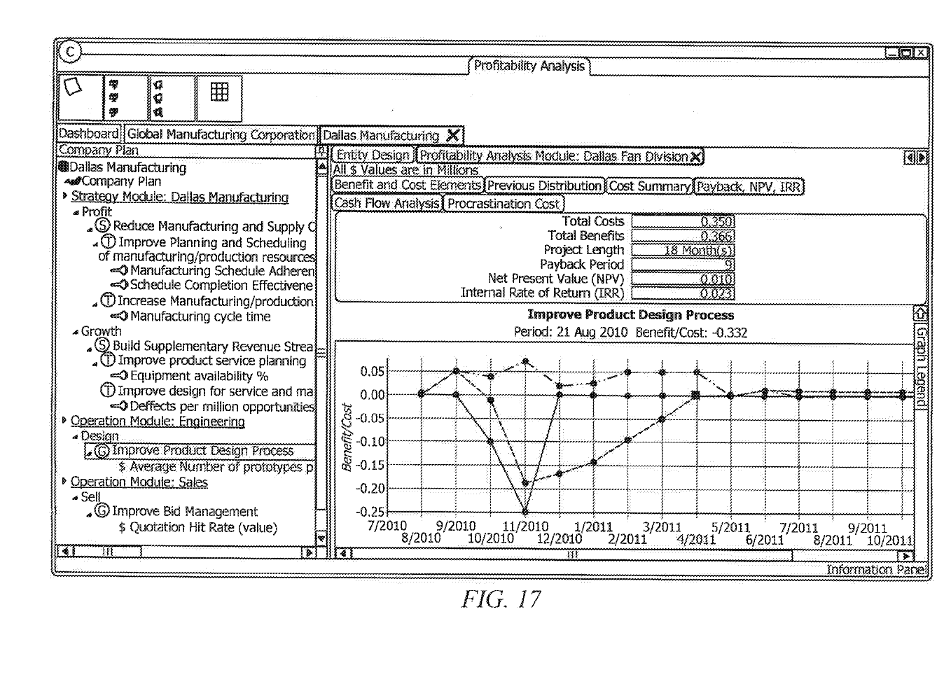

Once all of the cost components for an operational element have been entered, the user may then employ various views of the financial data to better analyze the impact that these costs may have on the operations model. By way of example, in FIG. 15, the user may optionally view the Return on Investment (typically graphically illustrated to show one or more of the following: NPV curve, Total Benefits Curve, Total Cost Curve, Payback Period, Internal Rate of Return, and/or Individual Cost Curves). These values may be calculated and presented as shown in FIG. 17. The user may also optionally view the cash flow projections, with the inflow and outflow of cash associated with the investment and execution of the operational element being shown for each month. Additionally, the user may optionally view the procrastination cost (typically graphically), which would illustrate the lost benefit cost to the entity in delaying execution of the operational element.

Solution design would typically be performed for each element of the operations model, so that the estimated costs entered in the operations model may be checked against reality. Often, solution design would be performed at a later stage of the strategy process, when quotes have been obtained allowing for a more real-world assessment of costs. Then, the projected costs in the operations model could be replaced by true costs, allowing for reassessment of the operations model. Typically, there is a link between the solution design module and the operations module, allowing for quick reference back to compare the costs. If solution design demonstrates that the estimated costs originally entered in the operations model are significantly off-base, then the operations model may be amended (typically by using/interacting with the operations module) to better reflect the costs. This may result in an iterative process for refining the costs of the operations model in a way that should hopefully lead to a better estimate of costs and, thus, of the associated value of the operations model (since value may be assessed as benefit minus cost). Solution design may also be used to ensure that there is a positive return on investment for the operations model. It should be noted that it is also possible to use such a solution design process as the initial way to build the costs of the elements in the operations model (rather than as a check on the initial estimate), in which case the solution design module might be integrated into the operations module. It is also possible for solution design to be updated over time as the strategy is actually implemented, providing a more accurate return on investment value projection for ongoing use within the execution control module. In such an instance, the updated cost projections would allow for refinement of ECI based on real-world implementation, perhaps providing a better gauge of performance in comparison to projections.

Another optional module that may be used to further refine the process could involve a process measurement module. Once an operations model has been created, the user may conduct process measurement to ensure that operationally the entity's processes have the capacity to provide the desired value. In other words, the process measurement module may be used to assess whether the business's processes are capable of being redesigned in a way that may provide the sought after value. Process measurement provides a greater degree of granularity in assessing the potential value that can be obtained by redesigning one or more operational processes within the entity, thus serving as a check on the ability to obtain value from the operations model in the real world (letting the user evaluate whether there is enough value in the proposed process changes that would result from implementation of the operations model to justify the changes). Operations users may use this tool to further refine the costs associated with the operational elements. Additionally, users could then modify the business's physical processes as detailed in process measurement in order to implement the business strategy. In doing so, changes could be made to the business's physical infrastructure and technology to bring then in line with the to-be process developed in process measurement. For example, new automation could be employed, upgraded machinery could be substituted, and/or production lines could be physically reconfigured to improve efficiency.

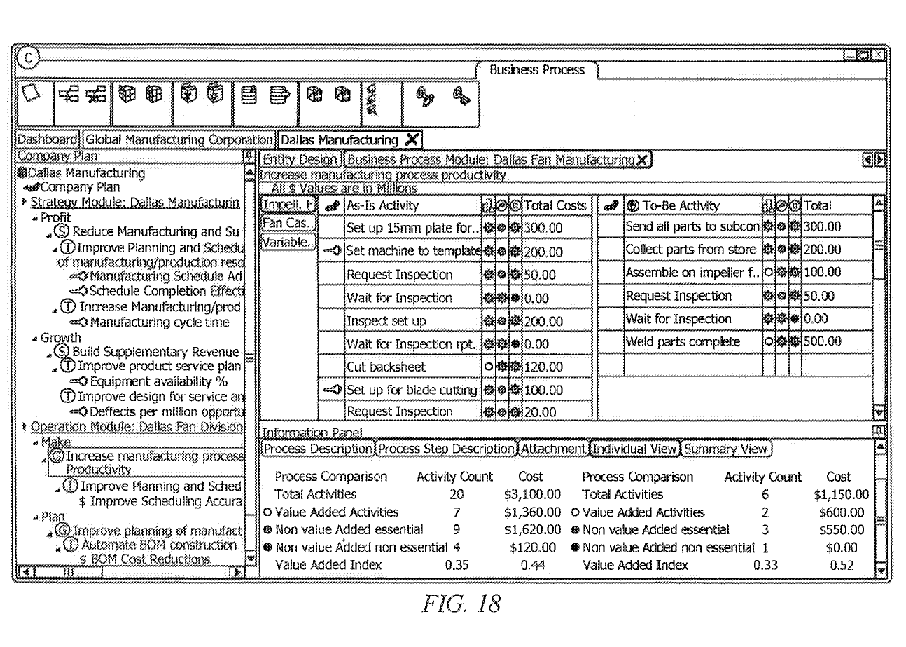

In process measurement, the user may enter/set the processes associated with supporting each operational element, comparing the current process to the process that will result from implementation of the operations model. In the embodiment shown in FIG. 18, the user would select an element from the operations model for analysis using the process measurement module. This brings up two windows, one for the process as-is, and one for the process as it is to be after reengineering. Then, for that operational element, the user would build a profile in the as-is window that describes the steps of the current process related to that operational element, along with the costs of conducting each step (based on materials, labor, and overhead costs, for example). KPI may also be associated with step(s). The user would also build a profile in the to-be window that describes the steps of the reengineered process (for implementing the operations model), along with costs of conducting each step. This provides a tool for quick comparison of the two processes, helping operational users to see the potential benefits available from improving the process.

The process measurement module may also provide two views that users may employ to analyze the comparison between the two processes. In the value view, each step may be defined as one of the following categories: (1) non-value added essential, (2) non-value added non-essential, or (3) value added. The user may view the number of steps falling into each category, and a sum of the costs associated with those steps. The user may also calculate a value add index for each category by calculating the percentage amount of the total process that each category represents (based on the number of steps classified in the category divided by the total number of steps in the process and multiplied by 100). By grouping the steps in these categories (and summing the number of each step in each category), the user may quickly identify additional ways in which the process may be improved (by attempting to minimize the number of non-value added steps, by way of non-exclusive example) and may quickly assess the effectiveness of the process (by looking at the value add index, by way of non-exclusive example). This may assist the user in performing a value comparison of the processes (based on the reduction of costs).

In order to evaluate the productivity of the processes, a velocity view may also be used. For a velocity view, each step in the processes may be designated as one of the following categories: work related, movement related, or delay related. The user may view the number of steps falling under each category, along with a sum of the associated costs. The user may also calculate a velocity index for each category by calculating the percentage amount of the total process that each category represents (based on the number of steps classified in the category divided by the total number of steps in the process and multiplied by 100), By grouping the steps in these categories and summing the number of each step in each category), the user may quickly identify additional ways in which the velocity of the process may be improved (by attempting to make delay steps transition to movement steps, and movement steps transition to work steps, by way of non-exclusive example) and may quickly assess the productivity of the process (by looking at the velocity add index, by way of non-exclusive example). This assists the user in performing a velocity comparison of the processes. Time is money in the business world, and the velocity index calculates the effect that unnecessary movements and/or delays can have on the process. The value add index and the velocity index may also be combined (typically by being multiplied together) to give an overall productivity index.

During the reengineering process (of defining the to-be process), the user may attempt to change the steps to move them into higher value added categories and/or to reduce movement and delays in a way that may improve efficiency. So, the process measurement module may be used to check to see if redesign of the operational processes of the business (from the as-is process to the to-be process) is capable of delivering the estimated value (from the operations model, for example) and/or is capable of being made more efficient and productive. This tool allows for iterative consideration of the steps in the to-be process, thereby assisting in reengineering the processes to deliver value (based on lean engineering principles).

In a further embodiment, activities within the processes contained in the operations model may themselves be measured and controlled using a derivation of benefit calculation specific to the activity step chosen. This would allow such a step to be considered as a constraint in the overall process and to be given a target value for measurement and control (within execution control, for example). The values could then be monitored and warnings could be generated in the execution control module in a manner similar to standard operation benefit calculations. In other words, specific to-be process steps can be measured and monitored, allowing for determination of whether such a process is off-target, and perhaps offering an earlier way to detect potential problems (before they might show up in standard ECI). Such process-based measurement also might provide the benefit of making it easier to determine the source of a problem (thereby making corrections easier to identify), while potentially also allowing process steps to be linked across units in an entity so that all potential consequences of a problem could be evaluated across the entity.

In an embodiment, solution design and/or process measurement would be performed to refine the operations model prior to synchronization of the operations model with the strategy model. This approach allows for the operations model to be fully fleshed out and finalized before synchronization compares it to the strategy model. Then, after synchronization is used (perhaps iteratively with modification of the strategy and/or operations models as needed to align the strategy and operations models), the overall corporate computer model can be finalized for execution control.

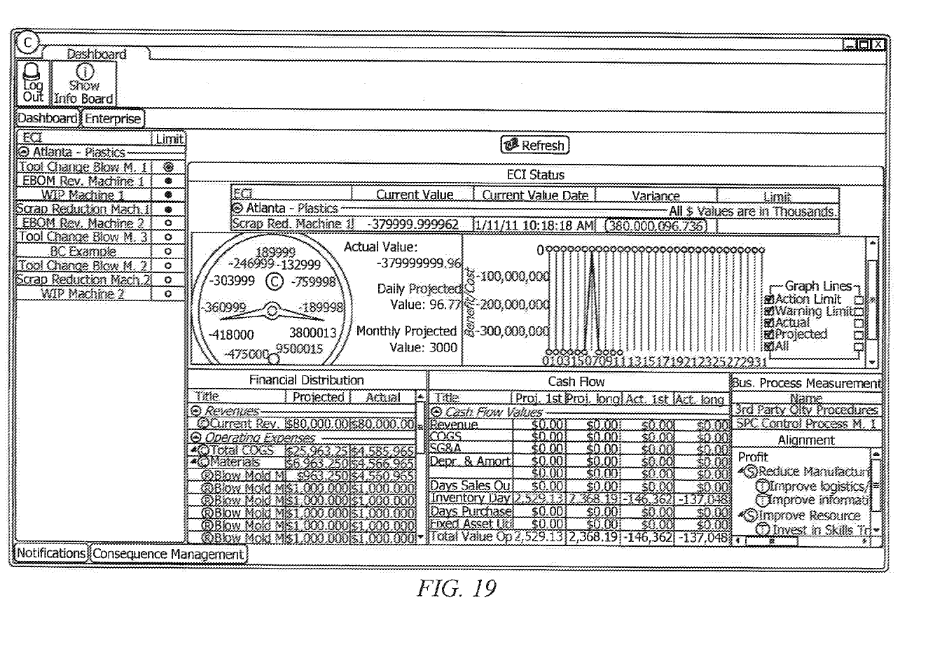

Another optional module which may be used to complete the closed loop measurement cycle is a consequence manager module. Once the various associations between strategic, operational, and financial elements have been set in the database(s) and the processes, people, and technology associations set, the user can access these associations and projections to performance once an ECI is measured. The consequence manager module typically works with the execution control module in order to provide decision makers within information about the potential consequences of a continued deviation from the operations model value projection curve, for example. The consequence manager module of the embodiment of FIG. 19 predicts consequences for on-going deviation, enabling decision makers to better understand the urgency level of a particular warning. The consequence manager module of FIG. 19 might project the financial consequences (by assuming that the deviation is on-going and using the benefit calculations/ECI to project consequences). Alternatively, the consequence manager module might project the impact of the deviation on the processes and/or resources (such as people and technology, for example), perhaps using links between process steps and related resources. This information could be provided to decision makers, along with the warning, giving more insight into the scope and/or urgency of the particular warning. While some or all of these features could be contained optionally within the execution control module, in some embodiments a separate consequence manager module is preferred.

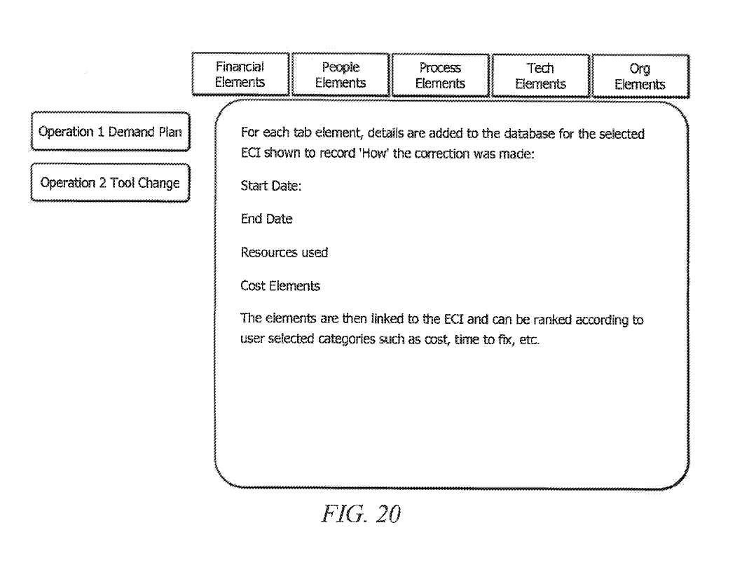

Another optional module that may assist in closing the planning and control loop is a correction manager module, as shown in the embodiment of FIG. 20. The correction manager module can have several inter-related functions. In the first instance, it might be used to record the steps and resources used to correct a deviation (i.e. if execution control indicates that current implementation of strategy is off-target). As a problem is resolved, a decision maker could record data relevant to the solution (such as the steps taken, resources used, and time for correction to return ECI within limits) in a database. Over time, the database would accumulate a series of recordings regarding different correction approaches for a problem. This could serve as a resource in the future, allowing future decision makers to quickly consider past correction approaches. The recordings regarding corrections would typically be linked to the warnings for specific EC (or other measurables), so that they would automatically be available whenever a specific warning is activated. In other words, the warning could include potential solutions based on past corrective actions for the same problem. And in another possible feature, the correction manager module could rank the possible corrective actions (based on minimizing timeline of correction or minimizing costs, for example). In these ways, correction management module could provide a much more useful warning, including possible solutions for consideration by decision makers. The entity then might make physical changes, modifying its technology, people, and/or processes to correct the deviation.

It should be understood that each of the modules described herein can be used independently or in any combination, depending on the user's purpose and desired goal. It should also be understood, however, that integrating the use of two or more of these modules provides a linked process providing synergies that enhance the effectiveness of the strategy building and implementation process. The preferred embodiment uses all of these modules to develop integrated and refined strategy and operations models (that jointly form a corporate model) that share a single direction, support each others goals, and are capable of realizing the desired value in the real world. The preferred embodiment may also link the processes in such a way that implementation of the unified corporate model can be measured and tracked to ensure that things are progressing according to plan (or alternatively that things are off-target and correction is needed).

It should also be understood that each strategy model may have multiple operations models (such as a different model for each different type of operation, or a different model for each division, by way of non-exclusive example) that together would implement the strategy model's goals. Furthermore, the process described above may be implemented for each tier of an n-tier company (i.e. a company having subsidiaries, divisions and the like, each of which may be broken into further constituent part), with the financial data rolling up to tie into an overall strategy-operations model for the n-tier company as a whole. This may provide a tool that is useful in developing a coordinated overall strategy within such a multi-tiered organization. So, the run-rate data would roll up (with lower child tier data summing to provide the parent tier data), and the projections based on run-rate data (such as the projected value/benefit calculations, by way of non-exclusive example) could also roll up (to provide an estimate of the overall value of the strategy from implementation of the operations model(s) throughout the n-tier corporate structure). Thus, the modeling process described above is quite flexible.

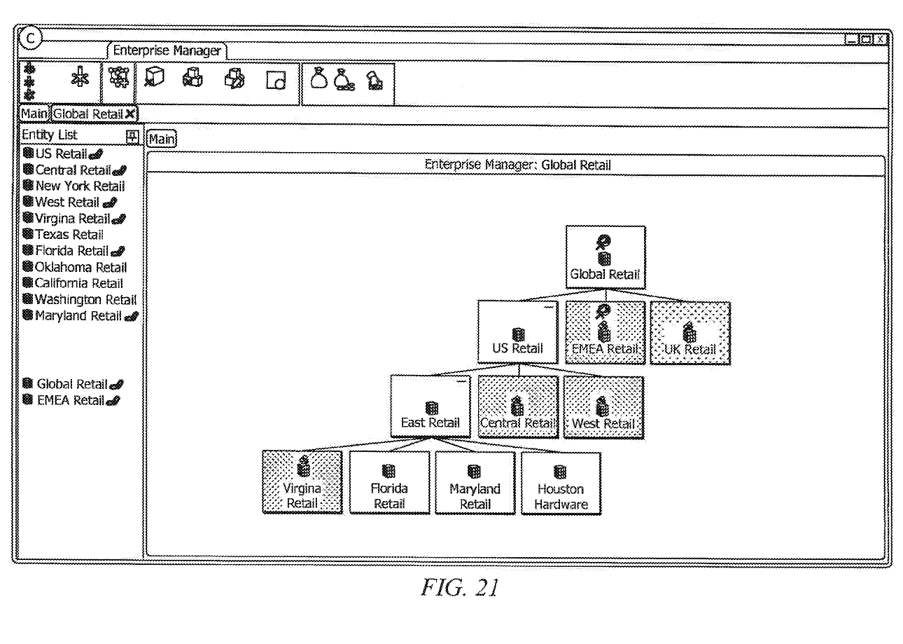

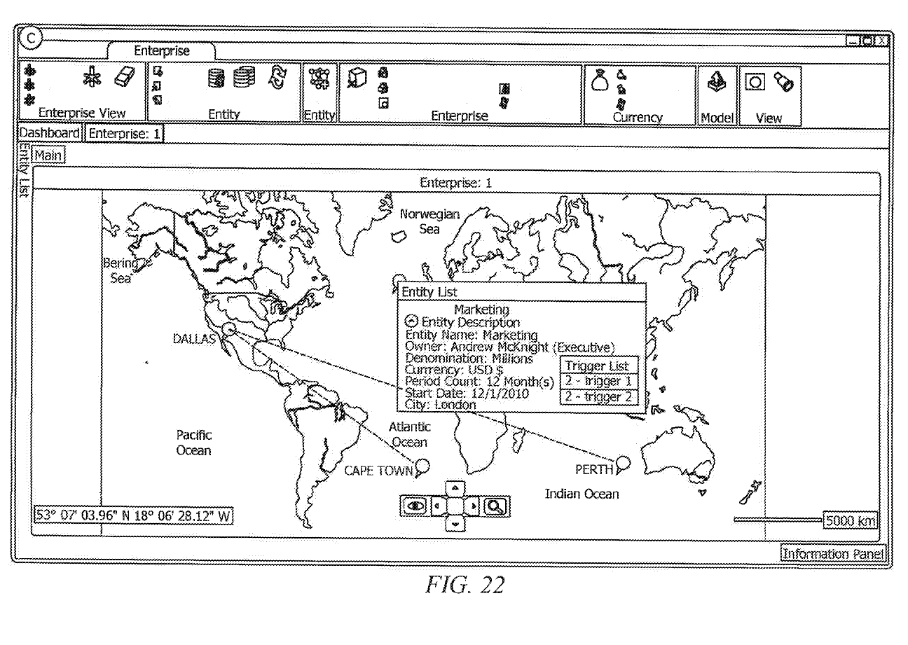

FIGS. 21 and 22 illustrate an embodiment of an n-tier hierarchical structure. The parent-child relationships (i.e. inks) between tiers typically mimic the organizational structure of the n-tier organization. So in this example, the organization is a collection of linked interconnected entities/units, each having strategic and operational models, with lower tiers feeding into higher level tiers. Links/dependencies may be established between any elements within any units of the n-tier organization, based on real-world dependencies. So for example, the processes in one unit could be linked to processes in an inter-related unit, such that a warning in a first unit (indicating that the process is off-target, for example) might trigger a linked warning in a second unit of the n-tier organization (which would be affected by the problem of the first unit). Such dependencies between warnings in different units within an n-tier organization would typically be established using database associations (such as guid and/or an association table), and may allow decision makers to connect/link performance associations so that consequences of ECI and process measurement in one part of the organization which may affect another area of the organization can be displayed and/or communicated to relevant decision makers. Such dependencies may be used for elements, processes, and/or ECI within a consequence manager module and/or a correction management module. An example might improve the clarity of this concept.

In the example, the n-tier organization is a global corporation with different regional companies or divisions around the world. Once division in India manufactures a part used by another division in Taiwan to build a consumer product which is sold to consumers by yet another division in the United States. Each division might have a computerized strategy operation model, which might include details about the processes used to implement the strategy. Each division could then measure the processes, tracking them to ensure that production is on-track (according to the computer model projections). Since the division in India supplies a necessary component part for the unit in Taiwan, and the unit in Taiwan then supplies a product for sale to the division in the U.S., both the U.S. and Taiwan divisions have some dependency on the division in India. Thus, an association/link could be created in the computer database tying the process in India to processes in the U.S. and Taiwan (such that a warning in India would also generate a warning in the linked divisions). That way, if there is sufficient deviation of ECI from the projection in the Indian division to activate a warning, a warning could also be activated in Taiwan and the U.S. (altering them of a possible delay in the supply chain, for example, thereby providing forewarning). This example should clarify one of the ways in which the above-described modeling processes could be used to improve an n-tier organization.

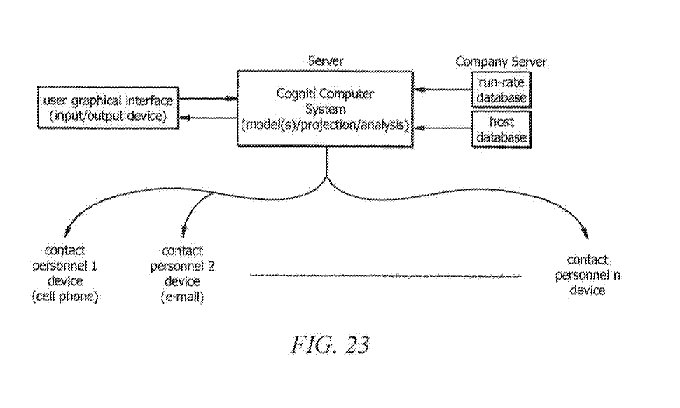

Turning now to the computerized framework which may be used to implement these processes, FIG. 23 illustrates a general embodiment of such a system. The embodiment of FIG. 23, comprises a user interface; a computer system (typically comprising one or more digital processors, most often comprising one or more semi-conductor chips) operable to build and store the corporate model, make projections, analyze whether the projections are being met, and transmit updates, notification, and/or warnings to designated contact personnel; a run-rate database storing reference run-rate data; a host database storing current financial data in the run-rate categories; and one or more contact personnel devices for receiving updates, notifications, and/or warnings. The user interface is typically an input/output device which may be a designated machine or a general purpose computer programmed with instructions (often in the form of software stored on computer readable media) to serve the designated function. The user interface provides a link that the user may utilize to connect to and interact with the computer system in order to build the corporate model and set up execution control to automatically monitor corporate performance and provide updates, warnings, and/or notice to designated contact personnel devices. The user interface may be directly linked to the computer system, or it may interact with the computer system over an Internet connection (in which case, the user interface would also typically include a modem).

The computer system of FIG. 23 would typically be located on a server in the case of an Internet or intranet connection. The run-rate database and the host database of FIG. 23 may each be a separate database, or they may be simply a portion of a larger database. Further, the run-rate database and the host database may be located at the entity's site (on a server), or they may be located at a separate site (if a hosted model accessible via the Internet is being used). The contact personnel devices may be any sort of electronic communication device for receiving transmitted messages, including by way of non-exclusive example, a personal computer or laptop capable of receiving any sort of electronic communication/transmission (such as e-mail), a cell phone or other wireless personal computing device (such as a PDA, for example a Blackberry or iPhone) capable of receiving e-mail, text messaging, etc., or a telephone (either a land-line or wireless communication device) capable of receiving an electronically generated audio message.

This computerized framework allows a user to construct a corporate computer model (including a strategy model and an operations model), to optionally link elements within the strategy model and/or the operations model as well as between the strategy model and the operations model, and/or to set the triggers, limits, and contact information for execution control (to provide for automated monitoring of corporate performance and notification of contact personnel in the event that the corporate performance deviates too much from the projections arising from the computer model). Once set up by the user, the computerized framework is automated and is operable to import current financial data from the host database (typically periodically based on the pre-set triggers) to evaluate corporate performance in comparison to the projections generated from the corporate model (specifically the benefit calculations and/or projection curve using the historical run-rate data from the run-rate database) and to communicate with the appropriate contact personnel in the event that the corporate performance is off-track from the projections (i.e. is outside the pre-set limits). In this way, the computerized framework can assist in constructing the computerized corporate model and can provide for automatic monitoring and notification.

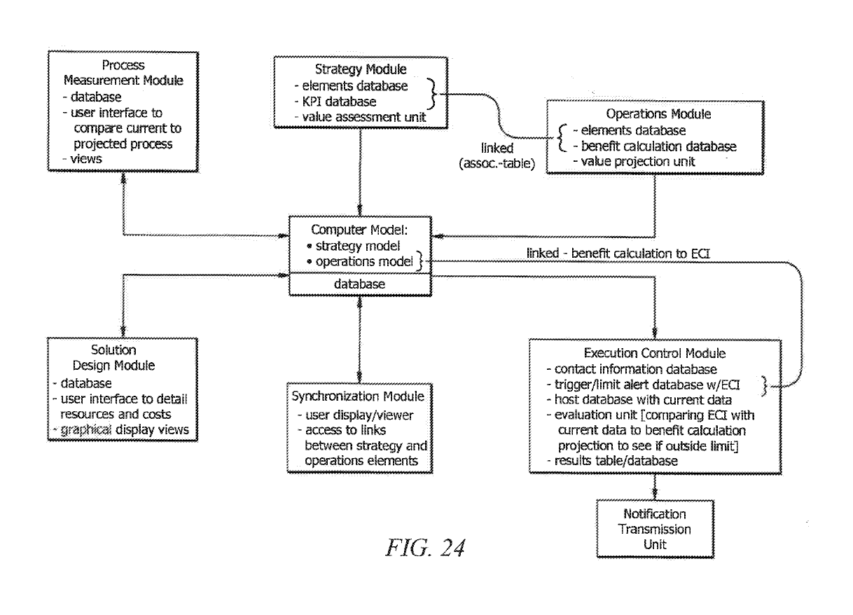

FIG. 24 provides additional detail regarding an embodiment of the computer system device. The computer system in FIG. 24 comprises a strategy module, an operations module, a computer model module, a solution design module, a process measurement module, a synchronization module, and an execution control module, which are linked to work together. The strategy module of FIG. 24 includes a strategy elements database, containing the pre-set elements from which the user may construct the strategy model along with their links and any associated KPI. The strategy module may also include a database of linked questions, descriptions, and/or attachments that may guide the user's selection as the strategy model is built. The strategy module of FIG. 24 also includes a value assessment unit which allows a user to assess the value of the selected strategy elements. A user may interact with the strategy module of FIG. 24 (typically via a user interface) to construct the strategy model by selecting elements (and possibly related KPI) from the strategy elements database to import into the computer model (or alternatively, to enter their own strategy elements or amend the pre-defined strategy elements), and may then use the value assessment unit to estimate the value associated with each such selected element. Typically, the value assessment unit interacts with the run-rate database to make value estimates. The strategy module would save the selected elements/KPI and assessed value (collectively, the strategy components) into the system model within the computer model database. Optionally, the user may also be able to save related notes and/or attachments in the model database, for future reference. Once the user has set all desired elements/KPI and assessed values for the system model, the system model would be stored in complete form in the computer model database.

In another embodiment, the strategy module may not include a pre-defined strategy elements database, but may instead provide tools to allow users to construct their own strategy elements and associated KPI. Then the user could assess value and store the related elements/KPI and assessed values in the database to form the strategy model. In such instance (when the user defines the elements rather than selecting them from a pre-set menu), the user would also need to define the links between various elements, KPI, and assessed values (and later the links between the strategy elements and their related elements from the operations model).

Similarly, the operations module of FIG. 24 comprises an operations element database, containing the preset elements from which the user may construct the operations model along with their links and any associated benefit calculations. And again, the module may include a database of questions, descriptions, and/or attachments (linked to elements) The operations module of FIG. 24 also includes a value projection unit which allows a user to estimate the value of the selected operations elements. Typically, the value projection unit interacts with the run-rate database to make value projections. A user may interact with the operations module of FIG. 24 (typically via a user interface) to construct the operations model by selecting elements and related benefit calculations from the operations element database to import into the computer model, and may then use the value projection unit to estimate the value associated with each such selected element. The operations module would save the selected elements and benefit calculations and projected value (collectively, the operations components) into the operations model within the computer model database. And again, the user might optionally be able to save related notes and/or attachments for future reference. Once the user has set all desired elements, benefit calculations, and projected values for the operations model, the operations model would be stored in complete form in the computer model database. It should also be noted that in the embodiment of FIG. 24, the operations elements in the operations element database are linked (typically by an association database) to related strategy elements in the strategy element database and the benefit calculations are linked to the KPI, and these links are also stored in the computer model database.

In one embodiment, these links/associations within the strategy or operations modules are accomplished using global unique identifiers (guid). More specifically, each piece of saved data in the computer system may be assigned a global unique identifier (saved in the database with it to serve as an address locator for that piece of data), and the global unique identifiers may be constructed in a segmented/hierarchical way that innately includes linkages to related pieces of data. So merely by way of a simplified example, if a business driver element in the strategy element database were to have a guid of 1, then one of its related strategy elements might have a guid of 1.1, one of its related tactic elements might have a guid of 1.1.1, one of its related KPI might have a guid of 1.1.1.1, and one of its related assessed values might have a guid of 1.1.1.1.1. Similarly, the links between various operations elements, benefit calculations, and/or projected values could be defined by hierarchically associated segmented guid. Thus, the guid associated with each piece of saved data (such as a strategy component (like strategy element, KPI, assessed value), or an operations components (like an operations element, benefit calculation, and/or projected value, etc.)) is comprised of hierarchically associated segments of data that indicate links and associations with other saved pieces of data in the system.

In other words, the guid incorporates the hierarchical design discussed in the above method process description, defining the linkages. The link is determined based on what type of data each particular segment of the guid represents within the hierarchy (such that by looking at the first segment of the guid, a specific category/type of association/link is being examined), and its value (which defines the specific data (perhaps by location address in a database) of that type to which the element represented by the guid is linked). So by way of example, in the guid for a specific selected KPI, the first segment might represent the specific related business driver element that was selected, the second element might represent the specific related strategy element that was selected, the third segment might represent the specific related tactic element selected, the fourth segment might represent this specific KPI, and the remaining segments would likely be empty (representing segments for additional related links further down the hierarchy). Thus, by knowing the guid for the KPI (which locates the KPI data in the database), it is easily discernable which other hierarchical elements it is related to. An automated computer query could easily look to the segments and values of the guid to identify links.

Guid could be used to effectively link/associate any hierarchical elements. So by way of example, guid could also link ECI, triggers/limits, contact personnel, solution design cost list, process measurement as-is and to-be process step charts, etc. to their related operations elements (such that these could all be operations components). And guid could be used to link descriptions, questions, notes, and attachments to their related strategy or operations elements. The size of each segment of the guid will typically depend on the number of each type of unit (such as elements, benefit calculations, KPI, assessed value, projected value, ECI, etc.) the system, and the number of segments will depend on the number of related pieces of data in the system.

While it might also be possible to use guids to relate operations elements to strategy elements, in the embodiment of FIG. 24 the links between operations elements and strategy elements could be stored in an association database or table (more typically a table within a larger database). So in this embodiment, the computer model database stores the guid of the selected strategy elements, KPI, assessed values, operations elements, benefit calculations, and projected values, and in doing so it contains not only these pieces of data that were selected/entered into the model (by reference to a location in the database), but also their relationships and links. Further, these guid links can be used in conjunction with the association database to link data in the operations module to data in the strategy module.

In another embodiment, the operations module may not include a pre-defined operations elements database, but may instead provide a tool that allows users to construct their own operations elements and associated business calculations. Then the user could project value and store the related elements/benefit calculations and projected values in the database to form the operations model. Similarly, in the strategy module, the user could be allowed to construct their own strategy elements and KPI (and store them in the database). In such instance (when the user defines the elements rather than selecting them from a pre-set menu), the user would also need to define the links between various elements, business calculations/KPI, and projected/assessed values (and the links between the strategy elements and their related operations elements).

Optionally, the computer system would also include a master control database, housing all of the elements of the strategy module and the operations module. The user would then be able to copy the complete master control database into one or more separate strategy and operations elements database(s), from which the user could then select specific elements for inclusion in the corporate computer model. While not required, this approach may help to prevent corruption of the data (as well as providing a secure source for correction if any data corruption does occur), as well as allowing for updating a master control database that several entities could jointly use without negatively impacting each entity's already created computer model.

Once the computer model has been built (including a strategy model and a related operations model), the user may optionally interact via the user interface with one or more of the solution design module, the process measurement module, and/or the synchronization module in order to refine the computer model. These are optional modules included in the embodiment of FIG. 24. The solution design module of FIG. 24 comprises a database for storing the detailed resource listing and associated cost data for each element of the operations model. The user interface may interact with the solution design module to allow the user to select an operations element from the operations model for solution design and to input the resources that would likely be required to accomplish the operations element, along with each resource's cost. The list of resources and costs for a specific operations element within the operations model may be stored on the database. In the embodiment of FIG. 24, the stored list is linked to the relevant operations element by its guid, with a segment of the guid for the list corresponding to the related operations element. The user interface may also interact with tools in the solution design module to allow for various views of the financial data, which may be graphically illustrated. Typically, the views would use the projected benefit value of the associated operations element and the costs determined by the resource list to illustrate return on investment. And while solution design would most often be performed for operations elements in the computer model, it could also optionally be performed similarly for strategy elements from the strategy model.

The process measurement module of FIG. 24 comprises a database for storing data related to the processes that are associated with each specific element of the operations model. Typically, the as-is process steps would be entered and saved, along with the to-be process steps (showing the ways in which the user proposes to alter the current process to achieve the related operations element). The user interface may interact with the process measurement module to allow the user to select an operations element from the operations model for process measurement and to input the as-is and to-be process steps. The steps of both processes may be stored on the database. In the embodiment of FIG. 24, the stored processes are linked to the relevant operations element by guid, with a segment of the guid for each process corresponding to the related operations element. The user interface may also interact with tools in the process measurement module to allow for various views of the processes, which may be graphically illustrated.

The synchronization module of FIG. 24 utilizes the association database (with links between strategy elements and operations element data) to display elements from the strategy model and associated elements from the operations model in a way that allows for comparison and evaluation of the content. In FIG. 24, the user may utilize the user interface to interact with the synchronization module by selecting an element from the strategy model for analysis. Upon selecting an element of the strategy model, all of the related operations elements which could have been selected from the operations module are displayed, and the related operations elements that are included (or conversely, not included) in the model would be designated. By way of example, the related operations elements that have been added into the operations model could be highlighted, bolded, marked by an asterisk, etc. This will allow a user to quickly see how well the operations model matches up with the strategy model (in terms of content), as this data is displayed on the user interface.

The synchronization module may also provide tools for additional views to assist in comparing the operations and strategy models. By way of example, the measurement view tool could be used to compare the benefit calculations associated with the selected KPI (using guid and the associations database). Or the value view tool may display the projected value of the operations element in comparison to the assessed value of the strategy element (using guid and the association database). Or the distribution view tool may display the operational elements' effects on the run-rate data in comparison to the run-rate data effects of the strategy elements (using guid and the association database). Or the projections view tool may compare the overall projections of benefit and cost of the operations elements with the same of the strategy elements (using guid and the association database).

Once the computer model of FIG. 24 has been finalized (using the solution design module, process measurement module, and/or synchronization module and perhaps iteratively modifying the strategy and/or operations model using the strategy and/or operations modules to achieve an integrated corporate model), then the user may store/update the final computer model on the computer model database. It is this model that can be used within the execution control module to evaluate whether the entity's current progress is on track with the projections derived from the model. The execution control module comprises a contact information database (which includes contact personnel, their contact information, and their relationship to specific elements—i.e. which. ECI they are associated with), a trigger/limit/alert database (which includes the times to evaluate ECI and the acceptable range of variance from the projected value of the benefit calculation/projection curve before an alert is issued), and a host database (which includes the entity's current financial data for evaluating the ECI or a link to an outside host database), and may also comprise an ECI database (in which the benefit calculations from the operations model are imported for use with the current data from the host database) and a results database (storing the results when the ECI are evaluated with the host data). Again, this execution control information could be linked to the related operation element by guid (since the execution control information may be operations components), with a segment of the guid for each corresponding to the related operation element. The execution control module of FIG. 24 also comprises an evaluation unit, that compares the ECI (calculated with current data from the host database) to the projected value based on the benefit calculations and which checks to see if the actual ECI value is outside the allowable limit, and a notification transmission unit, which notifies the designated contact personnel if the ECI with which they are associated in the contact information database is outside its limits. The notification transmission unit typically includes one or more communications means (such as a modem or telephone exchange).

In another embodiment, the user can also optionally provide for greater granularity in tracking performance by setting a value calculation for process steps identified as constraints to completion of the process during process measurement, and then creating an ECI (or more specifically a process execution control indicator based on these calculations) within the execution control module to check and notify whenever that specific process is off-target (typically by comparing the projection based on historic run-rate data to the value returned using current host data). This would be quite similar to that discussed above, but the process measurement module would also need to store the process step value calculation (and its guid) in its database.

In some embodiments, the execution control module would also include consequence management and/or correction management features, allowing for more detailed warnings that might include the possible (projected) consequences if the deviation continues un-corrected, along with possible corrective measures that may be taken (based on recordation of past corrective measures). And in other embodiments, a separate consequence management module might perform consequence management features and a separate correction management module might perform correction management features. Again, guid could be used to link related elements.

For an n-tier organization, and enterprise manager module could also optionally be used to link the strategy/operations modules of units throughout the organization in a hierarchical manner. FIG. 21 shows how the enterprise manager could be used to build the hierarchical links between units. The hierarchical view of FIG. 21 shows the basic hierarchical links between units, and more detailed associations can be shown/created. Once the ECI, processes, etc. are linked (typically using guid) and/or associations table(s)), the enterprise manager module may allow decision makers to view conditions across the n-tier organization and to interrogate potential consequences and corrections throughout the organization. FIG. 22, for example, shows a global map view. In this example, each unit may be denoted with a pin head graphic, and the color (green, yellow, or red, for example) of the pin head may indicate the status of the ECI being measured for that unit. The user/decision maker may click on a pin for display of additional, more detailed information about the unit (re: ECI, projection, relationship/links between units, consequences, and/or possible corrections, for example). Thus, the enterprise manager module may provide a useful graphical interface for evaluating issues across an n-tier organization.

It should be understood that the use of the word “database” is meant to be inclusive of any computer/electronic storage media (memory storage) capable of holding data and allowing the data to be extracted electronically. Thus, a database could be stored on a server, a hard-drive, or internal memory, or it could be located on a CD, disk, electronic tape, etc. by way of non-exclusive example. Likewise, the word “database” is intended to include one or more separate, independent database(s) (designated for a specific type of information) and/or a portion of a larger database (that may be partitioned into several smaller database tables). Thus, the term “database” as used herein is inclusive of a table in a database (which may include several such tables). In the preferred embodiment, most or all of the databases (such as the strategy element, operation element, model, association, trigger/limit, etc. databases, by way of non-exclusive example) described above would actually be tables within a single larger database, and this eventuality is intended to be included within any use of the term database (such that the strategy element database, by way of example could be an independent database or could be a portion of or table within a larger database, which could also hold the operations element database/table, by way of non-exclusive example). Thus, in various embodiments, there may be one or more databases for storing the model, the pre-set elements and links within the strategy and operations modules, the run-rate data, the contact personnel data, the host current financial data, the triggers/limits/alerts, the ECI results, etc.

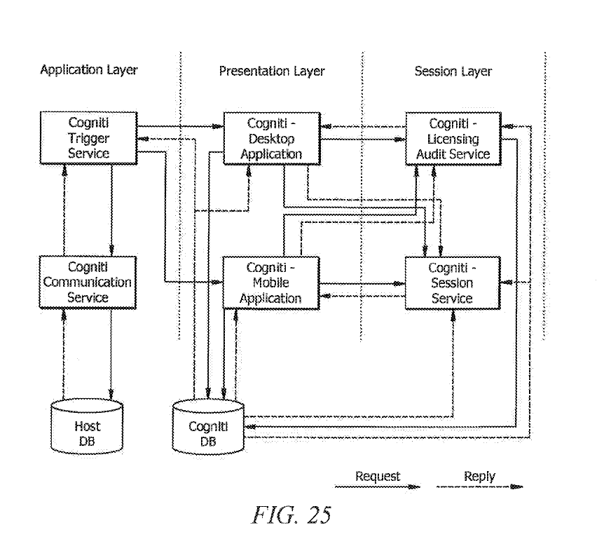

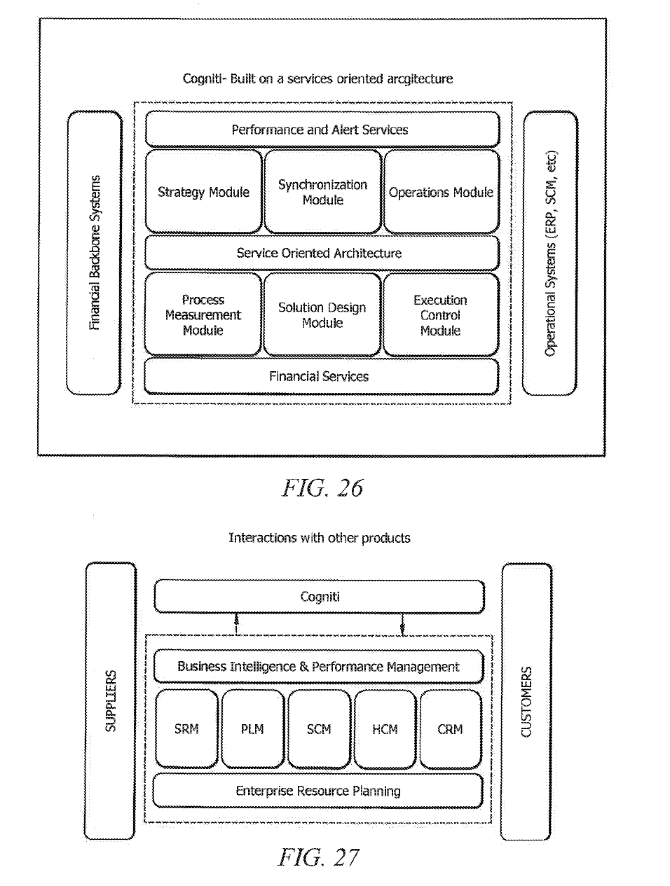

FIGS. 25 and 26 illustrate other embodiments of the computerized framework, and FIG. 27 illustrates the interaction between an embodiment of the system and other products. In implementing the types of processes described above using the embodiment of the computerized framework described in FIGS. 23 and 24, the user utilizes the user interface to interact with the computer system to build an integrated computer model and to set up automated execution control. The computer system device then utilizes the model (specifically the benefit calculations in conjunction with the run-rate data from the run-rate database) to make projections, and then utilizes the projections (in the form of ECI based on benefit calculations, along with the current data from the host database) to analyze and evaluate whether the model's projections are being realized. If the computer analysis determines that the current ECI are too far out of range away from the projections (i.e. outside the limits), then the computer system device (and typically the notification transmission unit in the embodiment of FIG. 24) automatically transmits an alert to the designated contact personnel (depending on the particular issue) using the designated contact means (such as e-mail over the Internet or text messaging using wireless cell transmission).

So, in the embodiment of FIG. 24, selected strategy elements are stored into a database as the strategy model, and the value of each selected strategy model element is assessed and stored in the database. Related strategy elements are associated, and typically these associations are performed by associating a guid with each element (wherein the guid is hierarchically associated and segmented in order to define the links between various components). Optionally. KPI may be associated with the selected elements as well. Thus, the model database may comprise the selected element guid (referring back to the database address for that element). Similarly, selected operations elements are stored in the database as the operations model, along with related benefit calculations, and the value of each selected operations model element is projected and stored in the database. Related operations elements are associated, and typically these associations are performed by associating a guid with each element (wherein the guid is hierarchically associated and segmented in order to define the links). So by way of non-exclusive example, the operations elements could comprise VCE and goals, and one segment of the guid would represent a particular VCE and another segment of the guid could represent a specific related goal. The value is typically projected using the selected benefit calculations and the run-rate data from the run-rate database, and this value may then be distributed (as a projection curve, for example). This value is typically linked to the operation model element and could also be represented by a specific segment of the guid. The benefit calculation (perhaps along with its projection curve) associated with each operation element may be rolled up to determine the total value of the operation model.

The operations model may be refined using solution control and/or process measurement. This might entail creating and storing in the database a cost list associated with each element in the operations model, and the association might be in the form of a guid. Also, process steps associated with each element of the operations model (possibly related as-is and to-be processes) may be entered and stored in the database, with the association typically in the form of a guid. The operations model may be amended iteratively in accordance with solution control and/or process measurement.

The operations model may be synchronized with the strategy model, using the association database/table. This may include displaying all the operations elements (from the operations module) that are associated with the selected strategy elements within the strategy model, along with some indication of which of these operations elements have been selected for the operations model. Then, current financial data may be imported from the host database, and the ECI (based on the benefit calculations) may be calculated by the execution control module of the computer device to evaluate the current status of the entity. The current status may be compared by the computer device to the projection based on the benefit calculations (typically in the form of projection curve). If the current status is outside of the designated limits, the contact personnel would be notified, via the notification transmission unit of the computer.

The computer system may operate on the entity's own system (perhaps with software structuring the modules within their own computer and instructing their own computer to perform the specific process tasks), or it could operate on a hosted system, in which the computer model would be hosted on an outside server, with the entity accessing the computer system via the Internet, for example. Further, the computer system could be a designated specific purpose machine designed to include the physical components/modules and to perform the process tasks, or it could be a general purpose computer machine programmed to be configured with the modules and to perform the process tasks. In such case, the program may be stored on computer readable media, which is then operable to transform the general purpose computer machine into a specific purpose machine that performs as discussed above.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings refer to a “Field of invention,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of and comprised substantially of Use of the term “optionally” and the like (such as may be used, can be included, or might, by way of non-exclusive example) with respect to any element of an embodiment means that the element or feature is not required, or alternatively, the element is included/required, both alternatives being within the scope of the embodiment(s).

What is claimed is:

1. A method comprising the steps of:
constructing on a computer a computerized strategy model;
constructing on the computer a computerized operations model;
projecting by the computer value of the operations model;
determining by the computer current value status; and
comparing by the computer current value status to projected value.

2. The method of claim 1 wherein:
constructing a computerized strategy model comprises:
setting a business driver element; and
setting one or more strategy elements associated with the business driver;
constructing a computerized operations model comprises:
setting a VCE element;
setting one or more goal elements associated with the VCE; and
setting one or more business calculations associated with each goal;
projecting value of the operations model comprises importing run-rate data from a run-rate database for use with the benefit calculations; and
determining current value status comprises importing current data from a host database for use with the benefit calculations or ECI derived from the benefit calculations.

3. The method of claim 2 further comprising:
identifying consequences for deviation of current value from projected value based on associations;
recording corrective actions taken to address deviation; and
providing suggested corrective actions based on recording of prior corrective actions.

4. The method of claim 2 wherein:
setting a business driver comprises selecting the business driver from a pre-set menu of business drivers on a database;
setting one or more strategies associated with the business driver comprises selecting the one or more strategies from a pre-set menu of strategies on the database;
setting a VCE comprises selecting the VCE from a pre-set menu of VCE on the database;
setting one or more goals associated with the VCE comprises selecting the one or more goals from a pre-set menu of goals on the database; and
setting one or more business calculations associated with each goal comprises selecting the one or more business calculations from a pre-set menu of business calculations on the database.

5. The method of claim 4 wherein:
the one or more goals are associated with the VCE by guid;
the one or more business calculations are associated with each goal by guid; and
each guid is hierarchically associated and segmented.

6. The method of claim 2 further comprising refining the operations and/or strategy models using solution design and/or process measurement.

7. The method of claim 2 further comprising transmitting a warning to pre-set contact personnel in the event that the comparison of current value status to projected value is outside a pre-set limit.

8. A computer device comprising:
a strategy module;
an operations module;
a computer model;
an execution control module;
a run-rate database; and
a host database.

9. The device of claim 8 wherein:
the strategy module comprises a database of one or more pre-set menus of strategy elements and their associations; and
the operations module comprises a database of one or more pre-set menus of operations elements and benefit calculations and their associations.

10. The device of claim 9 further comprising a database of the associations between related operations elements and strategy elements.

11. The device of claim 9 wherein the computer model comprises a database storing one or more selected operations elements and one or more benefit calculations associated with each selected operations element.

12. The device of claim 11 wherein the execution control module comprises a contact personnel information database and a trigger/limit database.

13. The device of claim 12 wherein the computer model projects value using the run-rate data and the benefit calculations, and wherein the execution control module determines current status using the host data and the benefit calculations or ECI based on them.

14. The device of claim 13 wherein the execution control module compares the current status to the projection to determine if the current status is outside the limit for the projection, and if so, transmits a warning according to the contact personnel information database.

15. The device of claim 14 further comprising:
a consequence manager module configured to project consequences in the event of a warning based on associations; and
a correction manager module configured to suggest corrective measures in response to a warning based on past corrective measures.

16. A computerized method comprising the steps of:
storing one or more strategy elements into a strategy model on one or more databases;
storing one or more operations elements into an operations model on the one or more databases;
projecting by a computer value of the operations model;
determining by the computer current value status; and
comparing by the computer current value status to projected value.

17. The method of claim 16 further comprising associating related elements in the strategy model; and associating related elements in the operations model.

18. The method of claim 17 wherein associating related elements comprises assigning a guid to each element in the strategy model and to each element in the operations model.

19. The method of claim 18, wherein each guid is hierarchically associated and segmented.

20. The method of claim 16 further comprising storing one or more benefit calculations associated with each operations element on the database; wherein:
projecting value of the operations model further comprises importing run-rate data from a run-rate database for use with the benefit calculations; and
determining current value status comprises importing current data from a host database for use with the benefit calculations or ECI derived from the benefit calculations.
